(19) United States
(12) Patent Application Publication
(10) Pub. No.: US 2022/0042185 A1
(43) Pub. Date: Feb. 10, 2022

(54) CATALYST FOR ELECTROCHEMICAL SYNTHESIS OF AMMONIA, METHOD FOR PREPARING SAME, AND METHOD FOR REGENERATING SAME

(71) Applicant: KOREA INSTITUTE OF SCIENCE AND TECHNOLOGY, Seoul (KR)

(72) Inventors: Hyun S. PARK, Seoul (KR); Sung Jong YOO, Seoul (KR); Jong Hyun JANG, Seoul (KR); Hee-Young PARK, Seoul (KR); Bora SEO, Seoul (KR); Jin Young KIM, Seoul (KR); Hyoung-Juhn KIM, Seoul (KR); So Young LEE, Seoul (KR); Jihyun CHOI, Seoul (KR); Jimin KONG, Seoul (KR); Hee Soo KIM, Seoul (KR); Gyu Seong YI, Seoul (KR)

(21) Appl. No.: 17/342,545

(22) Filed: Jun. 9, 2021

(30) Foreign Application Priority Data
Aug. 6, 2020 (KR) 10-2020-0098505

(51) Int. Cl. C25B 11/054; C25B 1/27; C25B 11/055; C25B 11/075

(52) U.S. Cl. CPC C25B 11/054; C25B 11/075; C25B 11/055; C25B 1/27

(57) ABSTRACT

The present disclosure relates to a catalyst for electrochemical synthesis of ammonia, which includes a metal sulfide, a method for preparing the same and a method for regenerating the same.

### DESCRIPTION OF GOVERNMENT-SUPPORTED RESEARCH AND DEVELOPMENT

This research was supervised by the Korea Institute of Science and Technology and supported by the Ministry of Science and ICT. Research project is Future materials discovery (R&D) and Research title is Development of structural alchemy technology for preparation of fractal catalyst (project ID: 1711105282).

### CROSS-REFERENCE TO RELATED APPLICATION

This application claims the priority of Korean Patent Application No. 10-2020-0098505 filed on Aug. 6, 2020, and all the benefits accruing therefrom under 35 U.S.C. § 119, the contents of which in its entirety are herein incorporated by reference.

### TECHNICAL FIELD

The present disclosure relates to a catalyst for electrochemical synthesis of ammonia, which includes a metal sulfide, a method for preparing the same and a method for regenerating the same.

### BACKGROUND ART

Ammonia (NH₃) is a very important chemical in various applications, including plastics, textile industry, agriculture and food production. In addition, it draws attentions as a hydrogen carrier that can be transported easily. As of 2017, the total production of NH₃ worldwide exceeded 150 million ton, and the demand for NH₃ is increasing consistently. At present, most of industrial production of ammonia depends on the traditional Haber-Bosch process whereby ammonia is produced from high-quality nitrogen and hydrogen gases at high temperature (300-500° C.) and pressure (150-300 atm). This process has the problems of a lot of natural gas consumption and severe environmental problems such as a large quantity of CO₂ emission. In order to resolve the problems of the Haber-Bosch process, a new ammonia synthesis method which is environment-friendly and consumes less energy is necessary.

Nowadays, electrochemical nitrogen reduction reaction (eNRR) has been proposed as an alternative method for producing NH₃ from N₂ and H₂O under ambient conditions. Although this NH₃ production method is environment-friendly and renewable, about 941 kJmol⁻¹ of energy is necessary to break the strong triple bond of the N₂ molecule. Therefore, eNRR has the problems of low FE efficiency and ammonia production yield. To solve this disadvantage, an electrocatalyst with high activity is necessary for renewable and environment-friendly conversion from N₂ to NH₃.

Meanwhile, although various eNRR catalysts have been investigated for improved eNRR performance, including noble metal, transition metal oxide, nitride, carbide, sulfide and metal-free catalysts, researches on the regeneration of catalysts for renewable eNRR with high yield has never been reported.

### REFERENCES OF RELATED ART

### Non-Patent Documents

(Non-patent document 1) Wang, M.; Liu, S.; Qian, T.; Liu, J.; Zhou, J.; Ji, H.; Xiong, J.; Zhong, J.; Yan, C., Over 56.55% Faradaic efficiency of ambient ammonia synthesis enabled by positively shifting the reaction potential. Nat. Commun., 2019, 10, 1-8.
(Non-patent document 2) Chu, K.; Liu, Y.-p.; Li, Y.-b.; Wang, J.; Zhang, H., Electronically Coupled SnO₂ Quantum Dots and Graphene for Efficient Nitrogen Reduction Reaction. ACS Appl. Mater. Interfaces 2019, 11, 31806-31815.
(Non-patent document 3) Cheng, H.; Ding, L. X.; Chen, G. F.; Zhang, L.; Xue, J.; Wang, H., Molybdenum carbide nanodots enable efficient electrocatalytic nitrogen fixation under ambient conditions. Adv. Mater. 2018, 30, 1803694.
(Non-patent document 4) Kong, J.; Lim, A.; Yoon, C.; Jang, J. H.; Ham, H. C.; Han, J.; Nam, S.; Kim, D.; Sung, Y.-E.; Choi, J., Electrochemical synthesis of NH3 at low temperature and atmospheric pressure using a γ2O3 catalyst. ACS Sustainable Chem. Eng. 2017, 5, 10986-10995.
(Non-patent document 5) Xue, Z.-H.; Zhang, S.-N.; Lin, Y.-X.; Su, H.; Zhai, G.-Y.; Han, J.-T.; Yu, Q.-Y.; Li, X.-H.; Antonietti, M.; Chen, J.-S., Electrochemical reduction of N₂ into NH₃ by donor-acceptor couples of Ni and Au nanoparticles with a 67.8% Faradaic efficiency. J. Am. Chem. Soc. 2019, 141, 14976-14980.
(Non-patent document 6) Li, S. J.; Bao, D.; Shi, M. M.; Wulan, B. R.; Yan, J. M.; Jiang, Q., Amorphizing of Au nanoparticles by CeOx-RGO hybrid support towards highly efficient electrocatalyst for N₂ reduction under ambient conditions. Adv. Mater. 2017, 29, 1700001.
(Non-patent document 7) LO, F.; Zhao, S.; Guo, R.; He, J.; Peng, X.; Bao, H.; Fu, J.; Han, L.; Qi, G.; Luo, J., Nitrogen-coordinated single Fe sites for efficient electrocatalytic N₂ fixation in neutral media. Nano Energy 2019, 61, 420-427.
(Non-patent document 8) Hao, Y.-C.; Guo, Y.; Chen, L.-W.; Shu, M.; Wang, X.-Y.; Bu, T.-A.; Gao, W.-Y.; Zhang, N.; Su, X.; Feng, X., Promoting nitrogen electroreduction to ammonia with bismuth nanocrystals and potassium cations in water. Nat. Catal., 2019, 2, 448-456.
(Non-patent document 9) Chen, P.; Zhang, N.; Wang, S.; Zhou, T.; Tong, Y.; Ao, C.; Yan, W.; Zhang, L.; Chu, W.; VW, C., Interfacial engineering of cobalt sulfide/graphene hybrids for highly efficient ammonia electrosynthesis. Proc. Natl. Acad. Sci. U.S.A., 2019, 116, 6635-6640.
(Non-patent document 10) Ren, J.-T.; Wan, C.-Y.; Pei, T.-Y.; Lv, X.-W.; Yuan, Z.-Y., Promotion of electrocatalytic nitrogen reduction reaction on N-doped porous carbon with secondary heteroatoms. Appl. Catal., B, 2020, 118633.
(Non-patent document 11) Bao, D.; Zhang, Q.; Meng, F. L.; Zhong, H. X.; Shi, M. M.; Zhang, Y.; Yan, J. M.; Jiang, Q.; Zhang, X. B., Electrochemical reduction of N₂ under ambient conditions for artificial N₂ fixation and renewable energy storage using N₂/NH₃ cycle. Adv. Mater. 2017, 29, 1604799.
(Non-patent document 12) Song, P.; Wang, H.; Kang, L.; Ran, B.; Song, H.; Wang, R., Electrochemical nitrogen reduction to ammonia at ambient conditions on nitrogen and phosphorus co-doped porous carbon. Chem. Commun., 2019, 55, 687-690.
(Non-patent document 13) Li, J.; Chen, S.; Quan, F.; Zhan, G.; Jia, F.; Ai, Z.; Zhang, L., Accelerated dinitrogen electroreduction to ammonia via interfacial polarization triggered by single-atom protrusions. Chem, 2020, 6, 885-901.
(Non-patent document 14) Geng, Z.; Liu, Y.; Kong, X.; Li, P.; Li, K.; Liu, Z.; Du, J.; Shu, M.; Si, R.; Zeng, J., Achieving a Record-High Yield Rate of 120.9 for N₂ Electrochemical Reduction over Ru Single-Atom Catalysts. Adv. Mater. 2018, 30, 1803498.

### DISCLOSURE

### Technical Problem

In an aspect, the present disclosure is directed to providing a metal sulfide-based catalyst which exhibits remarkable NRR activity and overcomes weak durability.

In another aspect, the present disclosure is directed to providing a method for preparing a metal sulfide-based catalyst convenient via a thermal heating process and a solid-state reaction.

In another aspect, the present disclosure is directed to providing a method for achieving remarkable eNRR reaction by using an electrochemical regeneration process between continuous eNRR reactions.

### Technical Solution

In an aspect, the present disclosure provides a catalyst for electrochemical synthesis of ammonia, which includes a copper-sulfur compound and N-doped carbon.

In another aspect, the present disclosure provides an electrode for ammonia synthesis, which includes the catalyst for ammonia synthesis described above.

In another aspect, the present disclosure provides a method for preparing a catalyst for ammonia synthesis, which includes a step of preparing a mixture of a copper precursor containing N and a sulfur precursor containing C and N; and a step of heat-treating the mixture.

In another aspect, the present disclosure provides a method for regenerating the catalyst for ammonia synthesis described above, which includes a step of synthesizing ammonia by electrochemical nitrogen reduction reaction (eNRR) in the presence of a catalyst for electrochemical synthesis of ammonia; and a step of regenerating the catalyst for electrochemical synthesis of ammonia after the step of synthesizing ammonia using Na₂S.

### Advantageous Effects

According to an aspect of the present disclosure, there is provided an electrochemical regeneration method providing remarkably superior ammonia synthesis activity as compared to the existing single metal or metal oxide catalyst and being applicable to continuous NRR. The method may be used to improve the production yield and synthesis speed of a catalyst in an environment-friendly way.

### BRIEF DESCRIPTION OF DRAWINGS

FIGS. 1A-1E show a schematic of a Cu₉S₅/NC synthesis process (1A), an XRD pattern of a Cu₉S₅/NC sample (1B), an SEM image of Cu₉S₅/NC (1C), a TEM image of Cu₉S₅/NC (1D) and an EDX elemental mapping of Cu₉S₅/NC (1E). The insert in FIG. 1D shows the enlarged lattice structure, and the larger image in FIG. 1D shows a result of observing the bulk state (low magnification). The insert in FIG. 1D shows the lattice structure of Cu₉S₅/NC and the crystal lattice of Cu₉S₅ observed by HR-TEM. From the TEM image analysis result, it can be seen that a composite structure wherein N-doped carbon is attached to Cu₉S₅ is formed. The interatomic distance corresponding to the (0015) crystal plane of Cu₉S₅ can be confirmed from the high-resolution TEM result.

FIGS. 2A-2D show a survey scan of Cu₉S₅/NC (2A) and high-resolution XPS results of Cu 2p (2B), S 2p (2C) and N 1s (2D) of Cu₉S₅/NC.

FIGS. 3A-3F show CV curves of Cu₉S₅/NC under Ar- and N₂-saturated conditions (3A), NH₃ yield and FE (%) of a Cu₉S₅/NC catalyst at different potentials (−0.4V to −0.8V vs RHE) (3B), a chronoamperometric curve Cu₉S₅/NC at −0.5 V for 16 hours (3C), XRD spectra of a Cu₉S₅/NC catalyst 1 hour after CA at −0.5 V in a N₂-saturated electrolyte solution (3D), chronoamperometric curves of Cu₉S₅/NC at −0.5 V under Ar- or N₂-saturated atmosphere (3E), and an XRD result of a Cu₉S₅/NC catalyst after HER at −0.5 V in an Ar-saturated electrolyte solution (3F).

FIGS. 4A-4F show the NH₃ yield and FE of Cu₉S₅/NC after repeating NRR test for 5 cycles (4A), XRD patterns of Cu₉S₅/NC after NRR at −0.5 V_{RHE} without Na₂S treatment and Cu₉S₅/NC after an electrochemical regeneration process at +0.1 V in 5 mM Na₂S (4B), NH₃ yield in a test for determining whether regeneration can be achieved at other potentials (4C), NH₃ yield and FE (%) after repeated electrochemical regeneration processes (4D), a ¹H (¹⁴N) NMR analysis result of NRR using a catalyst regenerated by a first electrochemical regeneration process at 0.1 V_{RHE} (4E), and CV curves of a Cu₉S₅/NC catalyst in 0.5 M Na₂SO₄ depending on the presence or absence of 5 mM Na₂S (4F).

FIG. 5A schematically illustrates electrochemical NRR and regeneration processes including an electrochemical reaction using a Cu₉S₅/NC electrode. FIG. 5B shows the structure of finally produced Cu₉S₅/NC.

FIGS. 6A-6B show the SEM (6A) and XRD pattern (6B) of a Cu₉S₅ catalyst synthesized by a hydrothermal method.

FIGS. 7A-7C show a TGA result of Cu₉S₅/NC (7A), N₂ adsorption isotherms of Cu₉S₅/NC and Cu₉S₅ (7B), and BJH plots of Cu₉S₅/NC and Cu₉S₅ (7C).

FIGS. 8A-8B show chronoamperometric curves of Cu₉S₅/NC at −0.4 to −0.8 V_{RHE} (8A), and a result of UV-Vis spectroscopy in a 0.5 M electrolyte after NRR test at −0.4 to −0.8 V_{RHE} (measurement was made by changing potential from −0.4 V to −0.8 V with a step size of 0.1 V) for 1 hour (8B).

FIGS. 9A-9C show a result of quantifying NH₃ using a NH₄Cl solution with a known concentration (ppm): (9A) UV-Vis spectra, (9B) calibration curve, (9C) images of solutions with increasing ammonia concentrations treated with the indophenol blue indicator.

FIG. 10 shows the UV-Vis absorption spectra of bare CP, OCV, N₂ and Ar when treated with a Cu₉S₅/NC catalyst and an indophenol indicator at −0.5 V_{RHE} for 1 hour.

FIG. 11 shows the ¹H (¹⁴N and ¹⁵N) NMR spectra of an electrolyte after NRR at −0.5 V_{RHE}.

FIGS. 12A-12D show a result of quantifying N₂H₄ using a solution with a known concentration (ppm): (12A) UV-Vis spectra, (12B) calibration curve, (12C) images of solutions with increasing ammonia concentrations subjected to the Watt and Chrisp method, (12D) UV-Vis absorption spectra of an electrolyte evaluated at −0.4 to −0.7 V_{RHE} for 1 hour by the Watt and Chrisp method.

FIGS. 13A-13B show the UV-Vis absorption spectra of Cu₉S₅/NC and Cu₉S₅ at −0.5 V_{RHE} for 1 hour (13A), and chronoamperometric curve of Cu₉S₅ at −0.5 V_{RHE} (13B).

FIGS. 14A-14B show the CV curves of Cu₉S₅ (14A) and Cu₉S₅/NC (14B) in the non-faradaic capacitance at a scan rate of 10-200 mV/s, and FIGS. 14C-14D show the electrochemical double-layer capacitance of Cu₉S₅/NC and Cu₉S₅ (14C) and the N₂-TPD profiles of Cu₉S₅/NC and Cu₉S₅ (14D).

FIGS. 15A-15B show the high-resolution XPS spectra of Cu 2p (15A) and S 2p (15B) of Cu₉S₅/NC after NRR at −0.5 V_{RHE}.

FIG. 16 shows the UV-Vis absorption spectra of bare CP, OCV, N₂ and Ar after chronoamperometric analysis at −0.5 V_{RHE} for 1 hour using the indophenol indicator. Specifically, after conducting chronoamperometry (CA) experiment of monitoring change in current by changing potential from −0.4 V (RHE) to −0.8 V with a step size of 0.1 V while maintaining each potential for 1 hour, the amount of NH₃ produced for 1 hour at each potential was quantified with absorption spectra.

FIGS. 17A-17B show the CA curves (17A) and UV-Vis absorption spectra (17B) obtained using a catalyst regenerated by electrochemical regeneration at various potentials (−0.3 to −0.9 V_{RHE}), detected with the indophenol blue reagent.

FIGS. 18A-18F show the chronoamperometric curves and UV-Vis spectra of Cu₉S₅/NC after an electrochemical regeneration process. The electrochemical regeneration was carried out once (18A, 18D), twice (18B, 18E) or 3 times (18C, 18F).

FIGS. 19A-19C show the SEM images of Cu₉S₅/NC, before (19A) and after (19B, 19C) NRR at 0.5 VRH. Prior to the NRR test, the prepared Cu₉S₅/NC has a complicated structure in which Cu₉S₅ and NC are mixed uniformly. After the NRR, the structure collapses, resulting in aggregation of Cu₂O (red circles) and scattering of NC (yellow circles).

FIG. 20 shows the production cycles of an electrochemical regeneration process using the indophenol indicator as well as images depending on potentials.

FIG. 21 shows the CV curves of a GC electrode and 5 mM Na₂S in a 0.5 M Na₂SO₄ electrolyte.

### BEST MODE

Hereinafter, specific exemplary embodiments of the present disclosure are described in detail referring to the attached drawings.

The described exemplary embodiments of the present disclosure are provided for the purpose of illustration only. The exemplary embodiments of the present disclosure may also be embodied into other various forms, without being limited to the described exemplary embodiments.

The present disclosure may be changed variously and may have various exemplary embodiments. The exemplary embodiments are not intended to limit the present disclosure, and should be understood to include all changes, equivalents and substitutes included in the technical idea and scope of the present disclosure.

In the present disclosure, when a portion is described to “include” a certain element, it does not mean that another element is excluded but means that another element can be included unless specially stated otherwise.

Catalyst for Electrochemical Synthesis of Ammonia

In exemplary embodiments of the present disclosure, there is provided a catalyst for electrochemical synthesis of ammonia, which includes a copper-sulfur compound and N-doped carbon.

The present disclosure discloses a copper-sulfur compound/NC (N-doped carbon) composite which exhibits superior NRR activity and is prepared by a thermal heating process and a solid-state reaction under an Ar atmosphere.

In an exemplary embodiment, the copper-sulfur compound may be represented by the chemical formula CuₓS_{y} (wherein x is 1.7-1.8 when y is 1).

In an exemplary embodiment, the copper-sulfur compound may be represented by the chemical formula CuₓS_{y} (wherein x is 8.5-9 when y is 5).

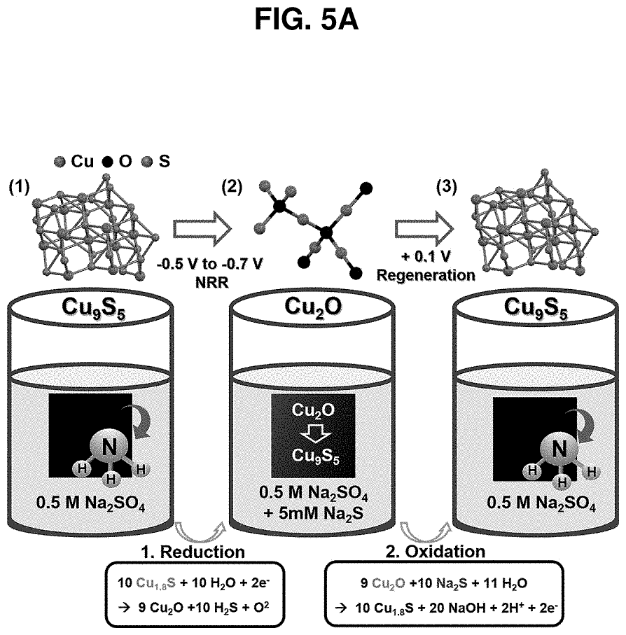

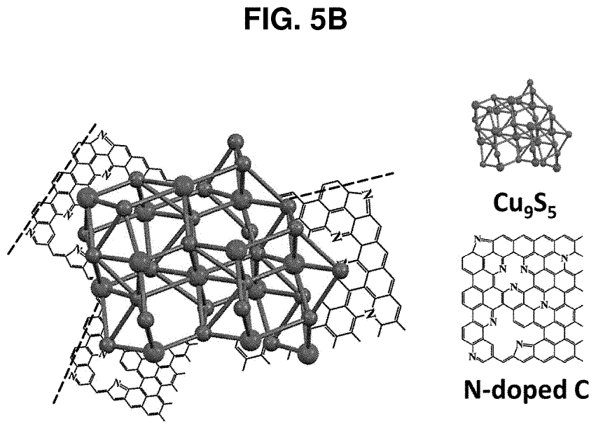

In an exemplary embodiment, the copper-sulfur compound may be represented by the chemical formula of Cu₉S₅. The actual structure of the copper-sulfur compound may be the same as (1) in FIG. 5A. When N-doped carbon is present together, a complex may be formed and exist in a dispersed state as shown in FIG. 5B.

In an exemplary embodiment, the copper-sulfur compound and the N-doped carbon may be complexed with each other and dispersed throughout the catalyst.

FIG. 5B schematically shows the structure of Cu₉S₅/NC formed according to an exemplary embodiment of the present disclosure. In the figure, the dotted lines means that the illustrated structure is repeated.

Referring to FIG. 5B, the N-doped carbon serves as a carrier or a support. The copper-sulfur compound may be dispersed on the N-doped carbon, and the N-doped carbon and the copper-sulfur compound may be complexed with each other and dispersed throughout the catalyst as a 3-dimensional structure.

In an exemplary embodiment, a mass ratio of the copper-sulfur compound may be 65-85% based on the total mass of the catalyst. If the mass ratio is lower than 65%, the apparent activity of an electrode may be low due to insufficient catalyst loading. And, if it exceeds 85%, the mass activity of the catalyst may decrease due to aggregation of excess catalyst and it may be difficult to achieve an NRR electron transfer effect due to low NC content.

In an exemplary embodiment, the catalyst may have a size of 0.1-10 μm.

In an exemplary embodiment, the catalyst may have a specific surface area (SSA) of 5-20 m²g⁻¹.

In an exemplary embodiment, the catalyst may have a total pore volume of 0.001-0.15 cm³g⁻¹.

In an exemplary embodiment, the catalyst may have an ammonia production yield of 600 nmol/hcm² or higher at −0.5 V_{RHE}.

In an exemplary embodiment, the catalyst may be regenerated using Na₂S.

Another exemplary embodiment of the present disclosure provides an electrode for ammonia synthesis including the catalyst for ammonia synthesis.

Method for Preparing Catalyst for Electrochemical Synthesis of Ammonia

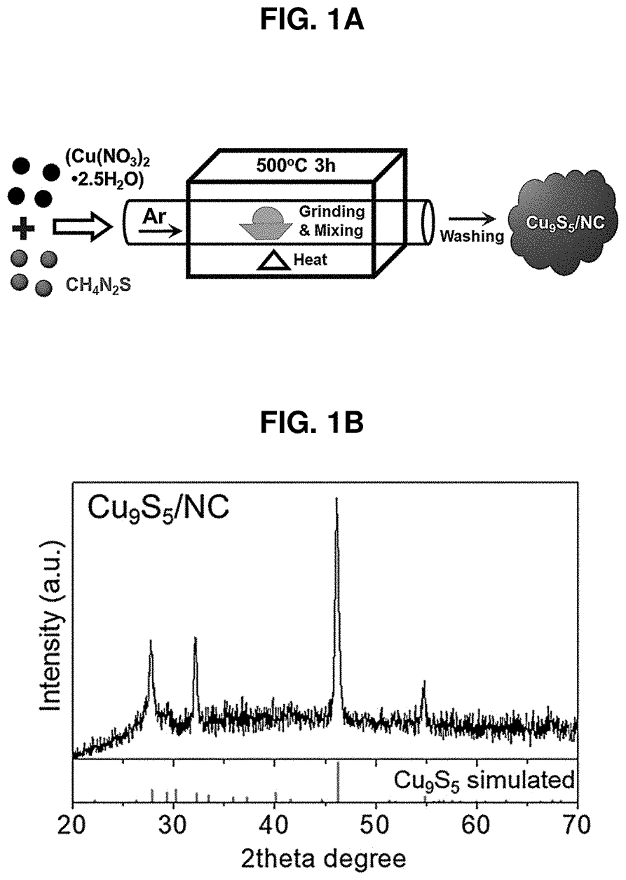

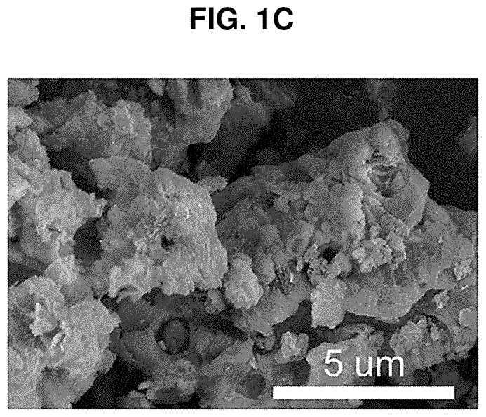

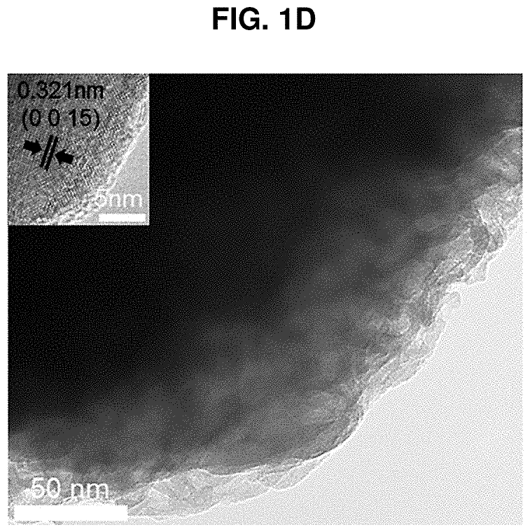

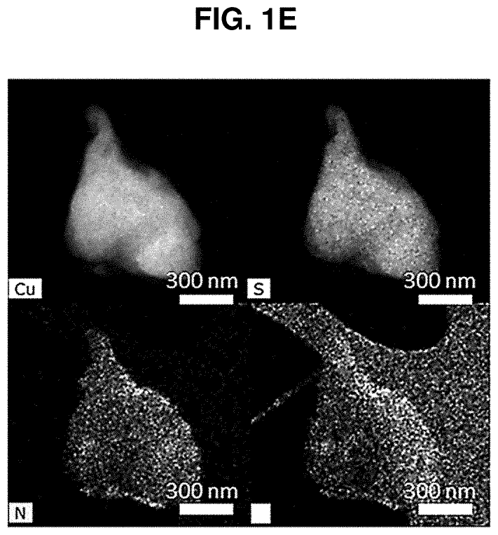

Another exemplary embodiment of the present disclosure provides a method for preparing a catalyst for electrochemical synthesis of ammonia, which includes: a step of preparing a mixture of a copper precursor comprising N and a sulfur precursor comprising C and N; and a step of heat-treating the mixture (see FIG. 1A).

In an exemplary embodiment, the copper precursor may be Cu(NO₃)₂.6H₂O and the sulfur precursor may be CH₄N₂S.

The copper precursor is a hydrate Cu(NO₃)₂.H₂O and the sulfur precursor is thiourea (CH₄N₂S). As Cu₉S₅ is formed from the S of the sulfur precursor and the Cu of the copper precursor under a high-temperature condition, and N-doped carbon is synthesized from the remaining C and N sources.

In an exemplary embodiment, in the step of preparing the mixture, the copper precursor and the sulfur precursor may be pulverized and mixed.

In an exemplary embodiment, the step of heat-treating the mixture may be performed by a solid-state reaction.

In an exemplary embodiment, the step of heat-treating the mixture may be performed at 400-600° C. for 1-5 hours.

In an exemplary embodiment, the step of heat-treating the mixture may be performed under Ar atmosphere.

Method for Regenerating Catalyst for Electrochemical Synthesis of Ammonia

Another exemplary embodiment of the present disclosure provides a method for regenerating a catalyst for ammonia synthesis, which includes: a step of synthesizing ammonia by electrochemical nitrogen reduction reaction (eNRR) in the presence of a catalyst for electrochemical synthesis of ammonia; and a step of regenerating the catalyst for electrochemical synthesis of ammonia after the step of synthesizing ammonia using Na₂S.

Despite the simple synthesis process and remarkable NRR activity of the catalyst for ammonia synthesis described above, the catalyst experiences composition change to Cu₂O during NRR due to the weak durability of the metal sulfide/NC (N-doped carbon). In order to overcome the disadvantage of the metal sulfide-based catalyst, the deteriorated of the catalyst such as Cu₉S₅/NC, i.e., Cu₂O, may be regenerated by an electrochemical regeneration process in between the continuous eNRR reaction. During the electrochemical metal oxide/sulfide redox regeneration cycle, NH₃ and H₂ are produced from dissolved N₂ and H₂O through repeated N₂ fixation reactions.

Until now, electrochemical NH₃ production using a catalyst regenerated by oxide/sulfide redox cycles mimicking the natural regeneration of a N₂ fixation catalyst has not been reported yet. This unprecedented method for achieving remarkable eNRR reaction provides an insight for an electrochemical N₂ reduction mechanism on the metal sulfide surface. Accordingly, it is expected that regeneration redox cycle of the eNRR catalyst provided in the present disclosure will provide a new method for preparing a material for an effective eNRR catalyst.

In an exemplary embodiment, the step of regenerating the catalyst for electrochemical synthesis of ammonia may be performed by immersing the catalyst for electrochemical synthesis of ammonia in an aqueous solution containing Na₂S and an electrolyte.

In an exemplary embodiment, the step of regenerating the catalyst for electrochemical synthesis of ammonia may be performed at a potential of 0.05-1 V_{RHE} for 30 minutes to 5 hours.

In an exemplary embodiment, after the step of regenerating the catalyst for electrochemical synthesis of ammonia, the step of synthesizing ammonia may be repeated using the regenerated catalyst.

Hereinafter, the present disclosure will be described in more detail through examples.

However, the following examples are for illustrating the present disclosure in more detail, and it will be obvious to those having ordinary skill in the art that the scope and contents of the present disclosure are not reduced or limited by the examples. In addition, it is also obvious that those having ordinary skill in the art that can easily carry out the present disclosure based on the disclosure of the present disclosure even for the matters experimental data of which are not presented and such changes and modifications belong to the scope of the appended claims.

### EXAMPLES

Experimental Methods

Reagents and Chemicals

CuCl₂.2H₂O (Sigma-Aldrich), Cu(NO₃)₂.2.5H₂O (Sigma-Aldrich), ethylene glycol (99.8%, Sigma-Aldrich), Na₂S (99%, Sigma-Aldrich), p-dimethylaminobenzaldehyde (99%, Sigma-Aldrich), thiourea (99%, Junsei), ethanol (95%, Daejung), Nafion resin solution (5 wt %, Sigma-Aldrich) and isopropyl alcohol (99.5%, Duksan) were used. All chemicals were of analytical grade and used without further purification.

Synthesis of Cu₉S₅/NC (Catalyst for Electrochemical Synthesis of Ammonia)

A Cu₉S₅/NC catalyst was prepared by pulverizing Cu(NO₃)₂.2.5H₂O and CH₄N₂S powders and then heat-treating the same in a crucible (FIG. 1A).

Specifically, Cu(NO₃)₂.2.5H₂O (0.8 g) and thiourea (1.2 g) were mixed as follows. The precursors were mixed well physically in an agate mortar by agitating for about 5 minutes.

After transferring to a ceramic crucible, the mixture was heated in a tube furnace at 773 K (500° C.) for 1 hour with a heating rate of 8.3 K/min under Ar gas atmosphere. The prepared catalyst was washed 4 times with deionized water.

Synthesis of Cu₉S₅

CuCl₂.2H₂O (1 g) and thiourea (1 g) were added to ethylene glycol (40 mL). After stirring for 30 minutes, the precursors were heated in an oven controlled to 150° C. (423 K) for 4 hours under an autoclave condition. Then, the prepared catalyst was washed several times with deionized water and ethanol.

NRR Measurement

For preparation of a working electrode, the wet-dispersed Cu₉S₅/NC or Cu₉S₅ catalyst was sprayed manually onto carbon paper (2.5 cm×2.5 cm, Toray T-120) and then dried in a desiccator at ambient temperature. The loading amount of the catalyst coated on the electrode was set to 1 mg/cm². A catalyst ink was prepared by mixing 10 mg of the catalyst powder with 1 mL of an IPA solution. Prior to starting experiment, the working electrode was rinsed with 0.5 M Na₂SO₄ (pH 7) to remove water-soluble pollutants attached to the surface. As an electrolyte for eNRR, 0.5 M Na₂SO₄ (99%, aqueous solution) was used. 10 mM H₂SO₄ was used to trap NH₃ in the electrolysis chamber. The cathode and anode chambers of H-cell were separated using an anion exchange membrane (FAA-3, Fumatech), which were pretreated with 1 M KOH for 24 hours prior to the test, and then further pretreated with DI water for 1 hour. The Bio-Logic SP-300 potentiostat was used for all electrochemical experiments. Electrochemical experiments were conducted at room temperature under atmospheric pressure. For a 3-electrode system, a standard calomel electrode (SCE) and a graphite rod were used as a reference electrode and a counter electrode, respectively, and carbon paper covered with the catalyst powder was used as a working electrode. All potentials were referenced to the reversible hydrogen electrode scale. The activity of electrochemical ammonia synthesis was measured by chronoamperometry (CA) for different potentials from −0.4 to −0.8 V_{RHE} for an hour. For NRR, ¹⁴N₂ (99.999%, Sinyang) and ¹⁵N₂ (98 atom %, Sigma) were bubbled for about 20 minutes prior to measurement and then purged into the cathode compartment at a flow rate of 250 ccm and 5 ccm, respectively, during the experiment. The redox characteristics of the catalyst loaded onto a glossy carbon (GC) electrode were investigated in different electrolytes by cyclic voltammetry (CV) at a scan rate of 50 mV/s.

Regeneration of Metal Chalcogenide Electrode

During the NRR measurement, the Cu₉S₅/NC electrode was decomposed in an aqueous solution (0.5 M Na₂SO₄) to Cu₂₀/NC at −0.5 V_{RHE}. The electrode was regenerated by oxidizing and restoring to Cu₉S₅ via an electrochemical regeneration process. For regeneration, the used electrode was treated for 1 hour at a constant potential of 0.1 V_{RHE} in an aqueous solution containing 5 mM Na₂S and 0.5 M Na₂SO₄. After completely washing the regenerated electrode with deionized (DI) water, NRR was measured at −0.5 to −0.7 V_{RHE} as described above. After repeating N₂ reduction and electrochemical sulfurization processes several times, the produced NH₃ was quantified by the indophenol method.

Physical Properties

X-ray diffraction (XRD) patterns were obtained on MiniFlex-2 (Rigaku) equipped with Cu Kα radiation (λ=1.5406 Å). Scanning electron microscopy (SEM) images were obtained using the Inspect F50 microscope with an acceleration voltage of 10 kV. TEM images were recorded using a transmission electron microscope (Talos F200X), and X-ray photoelectron spectroscopy (XPS) spectra were measured using the PHI VersaProbe system with a 100-W ALK α X-ray source.

Low-temperature nitrogen adsorption-desorption isotherms were measured at 77 K (−196° C.) using the volumetric adsorption analyzer BEL (BEL, Inc., Japan). Prior to the measurement, all the samples were deaerated at 173 K (100° C.) for 12 hours under a constant-volume condition in vacuo. Specific surface area was measured from the nitrogen adsorption isotherms by the Brunnauer-Emmet-Teller (BET) method in the relative pressure (P/P₀) range of 0.05-0.20. Pore size distribution (PSD) was measured by the Barrett-Joyner-Halenda (BJH) method. Total pore volume was determined at P/P₀ of 0.99. Temperature-programmed desorption (TPD) was performed on Micromeritics AutoChem II 2920 TPR/TPD.

Thermogravimetric analysis (TGA) was conducted on SDT Q600 (TA Instruments Inc., New Castle, De, USA).

NH₃ Detection

The concentration of the produced ammonia was measured by the indophenol blue method. First, 1 mL of a sample solution was added to an electrochemical cathode reactor. Then, 1 mL of a phenol solution (0.64 M C₆H₅OH, 0.38 M NaOH and 1.3 mM C₅FEN₆Na₂O) and 1 mL of a hypochlorite solution (55 mM NaOCl and 0.75 M NaOH) were added. After reaction at room temperature for 2 hours, the absorbance of the sample was analyzed at 900-350 nm by UV-vis spectroscopy. UV-Vis spectra were obtained using the Cary UV-vis 100 spectrophotometer (Agilent). Absorbance peaks at 633 nm were calibrated by subtracting the background absorbance measured at 875 nm. In the UV-Vis spectra, the background absorbance means the absorbance of the bulk electrolyte solution at 0 ppm (NH₃). In addition, the production of NH₃ was confirmed from the ¹⁴N and ¹⁵N spectra acquired by ¹H NMR (nuclear magnetic resonance) using Bruker Avance III HD 400 MHz.

N₂H₄ Detection

The quantity of the byproduct, N₂H₄, produced during the electrochemical NH₃ production was measured by the Watt and Chrisp method. A mixture of p-dimethylaminobenzaldehyde) (6 g), HCl (37%, 30 mL) and ethanol (300 mL) was used as an indicator. Measurement was performed after mixing 2 mL of an electrolyte and 2 mL of the indicator solution for 5 minutes. For measurement of the hydrazine, a standard curve was plotted from a series of N₂H₄.H₂O solutions of different concentrations, diluted with 0.5 M Na₂SO₄. The absorbance of N₂H₄ was measured at 455 nm.

Calculation of Faradaic Efficiency (FE) and NH₃ Yield

Assuming that three electrons are required to produce one NH₃, FE is calculated as follows.

FE=(3F×V×C_{NH3})/(m_{NH3}×Q)

In the above equation, F is the Faraday constant (96485 C mol⁻¹), V is the volume (mL) of an electrolyte, C_{NH3} is the concentration (g/mL) of NH₃ determined 1 hour after CA for UV-Vis measurement, m_{NH3} is the molar mass of NH₃ (17 g/mol), and Q is the total charge (C) accumulated for 1 hour during CA.

The NH₃ yield is calculated as follows.

(1) Production speed of NH₃ normalized to the mass of catalyst, rₘₐₛₛ=(C_{NH3}×V)/(m_{NH3}×m_{Cat})

(2) Production speed of NH₃ per time, normalized to geometrical area, rₐᵣₑₐ=(C_{NH3}×V)/(m_{NH3}×A)

In the above equations, C_{NH3} is the concentration (g/mL) of determined 1 hour after CA for UV-Vis measurement, V is the volume (mL) of an electrolyte in the cathode chamber, m_{NH3} is the molar mass of NH₃ (17 g/mol), m_{Cat} is the mass (mg) of the cathode catalyst, and A is the geometrical area of the electrode (6.25 cm²).

### TEST EXAMPLES

Observation of Synthesized Catalyst

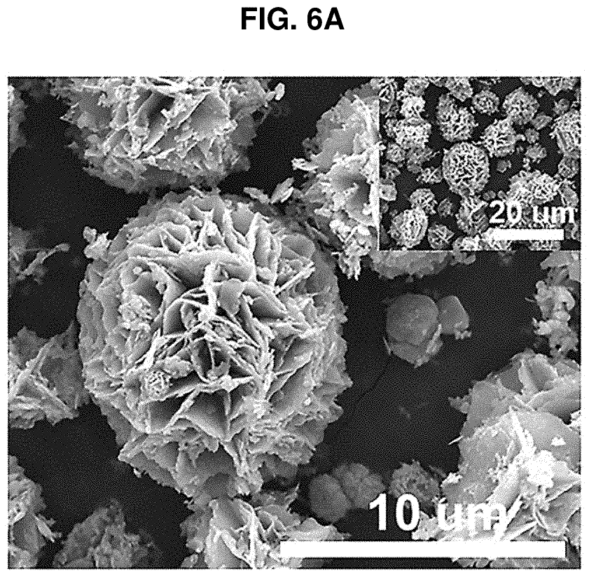

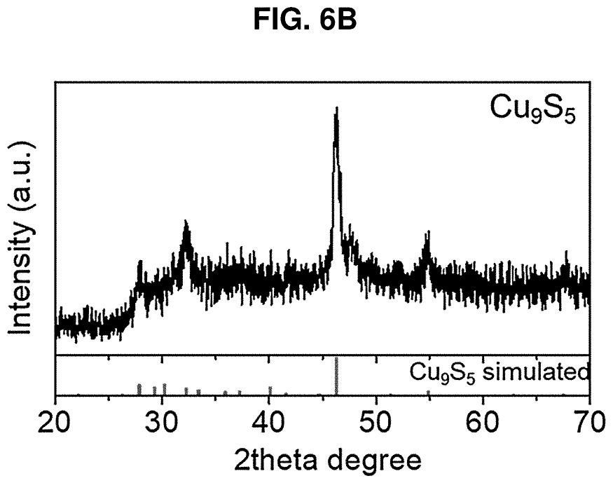

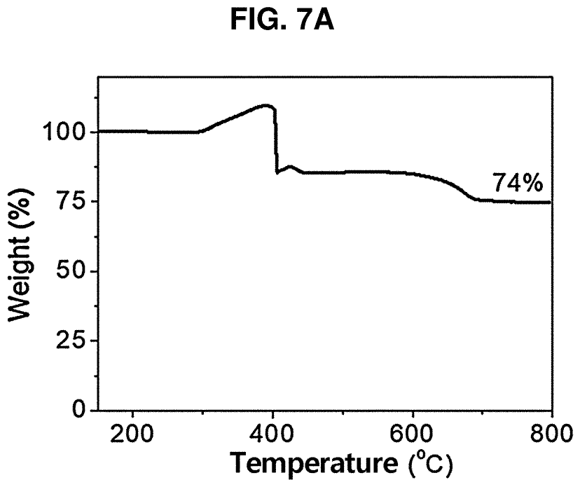

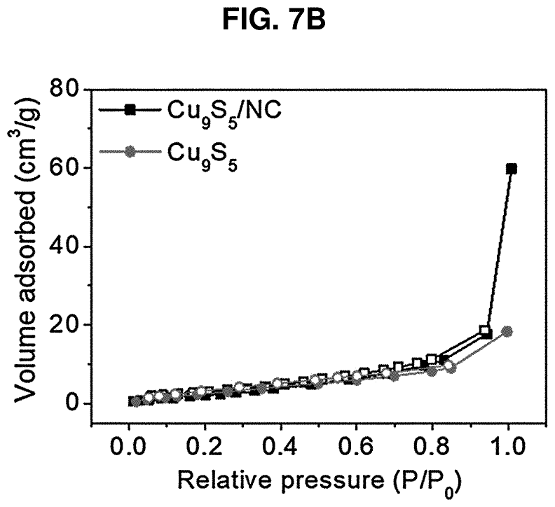

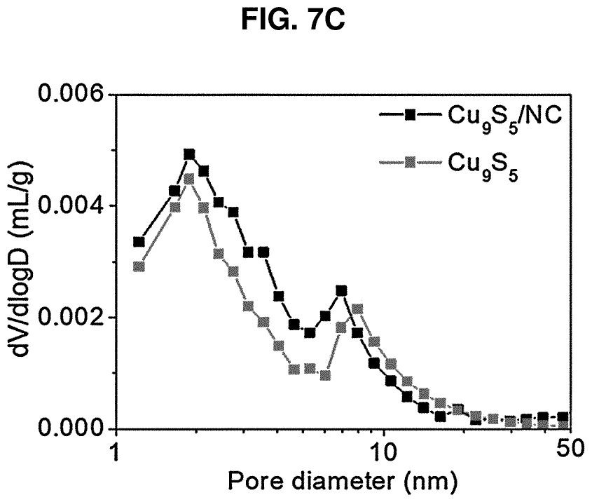

The XRD pattern of the prepared catalyst is shown in FIG. 1B. The XRD peaks of Cu₉S₅/NC were observed at 2θ=27.8°, 29.5°, 32.2°, 37.6°, 42.0°, 5.3°, 48.8° and 54.7°, which correspond to the (0015), (107), (1010), (0114), (0117), (0120), (119) and (1115) planes, respectively, of hexagonal-phase Cu₉S₅ (JCPDS No. 26-0476, FIG. 1B). The morphology of the sample was observed by SEM and TEM (FIGS. 1C-1D). A chunk with no uniform shape can be seen from FIG. 1C. The size of the Cu₉S₅/NC composite was confirmed to be 1-5 μm from the SEM image. The structure of the Cu₉S₅/NC composite can be confirmed from the TEM image. The HR-TEM lattice image of Cu₉S₅/NC shows 0.321-nm lattice fringes corresponding to the (0015) plane of Cu₉S₅ and carbon materials attached to Cu₉S₅ (FIG. 1D). The NC-free Cu₉S₅ sample shows a flower-like morphology along with sheet-like plates with a size of 5-10 μm (FIG. 6A). However, the crystal structure was not affected by the presence of NC as can be seen from the XRD pattern (hexagonal Cu₉S₅, JCPDS No. 26-0476, FIG. 6B). The proportion of the active site of the Cu₉S₅/NC catalyst, i.e., the mass ratio of Cu₉S₅, was 74% as estimated from the TGA analysis (FIG. 7A).

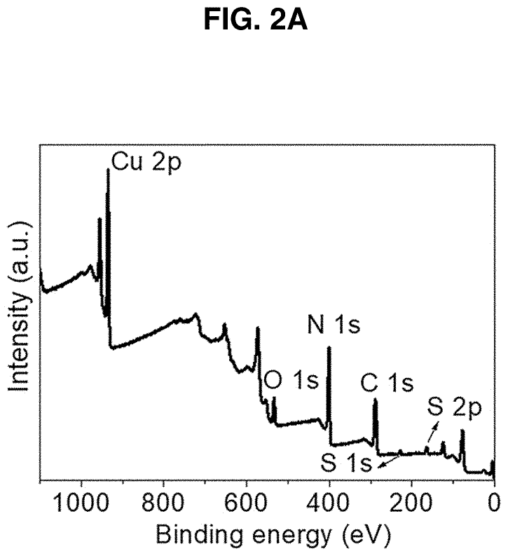

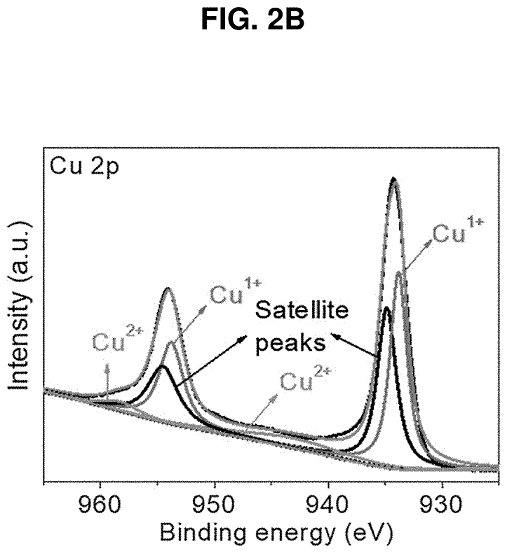

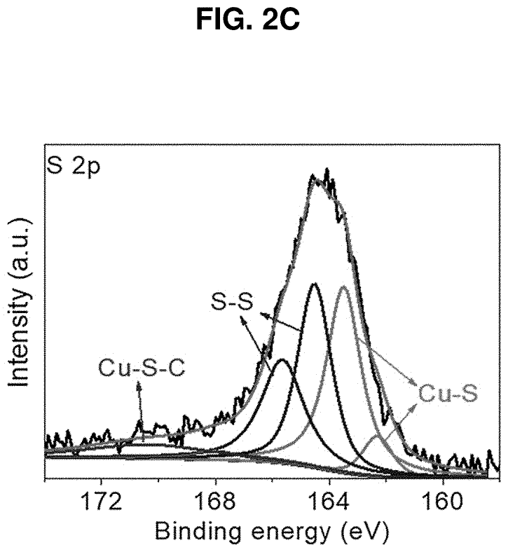

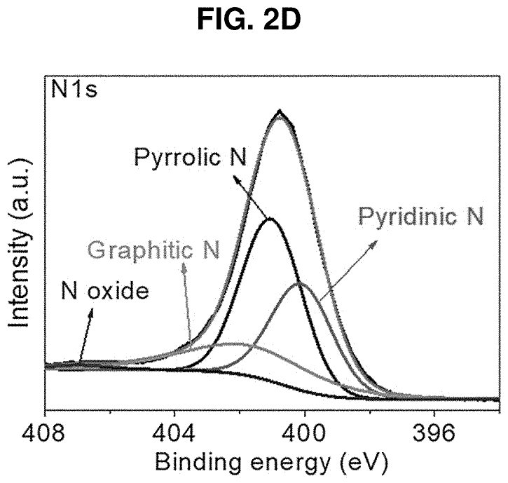

As a result of energy-dispersive X-ray spectroscopy (EDX) mapping, it was confirmed that Cu, S, C and N were distribute uniformly throughout the entire structure of the Cu₉S₅/NC catalyst (FIG. 1E). The XPS survey spectrum confirms the presence of Cu, S, C and N in the composite and is consistent well with the EDX mapping result (FIG. 2A). The Cu 2p spectra show two main peaks at 933.9 and 953.8 eV, which correspond to Cu and Cu¹⁺ of Cu₉S₅/NC, respectively. A pair of weak peaks at 943.7 and 958.4 eV correspond to Cu and Cu²⁺ of Cu₉S₅/NC, respectively. The remaining peaks (at 934.9 and 954.7 eV) are satellite peaks of Cu (FIG. 2B). In the high-resolution S 2p spectra of FIG. 2C, the peaks at 162.3, 163.5, 164.6, 165.7 and 170.3 eV reveal the presence of the covalent bonds Cu—S (162.3, 163.5 eV), S—S (164.6, 165.7 eV) and Cu—S—C (170.3 eV). The high-resolution N 1s spectra are shown in FIG. 2D. The four peaks at 400.1, 401.1, 402 and 406.7 eV correspond to pyridinic N, pyrrolic N, quaternary N and N oxide, respectively.

The conductive support, i.e., NC, was used in Cu₉S₅/NC to improve the active surface area of the catalyst. For characterization of the catalyst, the textural property of Cu₉S₅/NC and Cu₉S₅ was investigated by N₂ adsorption analysis. From the N₂ adsorption-desorption isotherms, the specific surface area (SSA) and total pore volume of Cu₉S₅/NC and Cu₉S₅ were determined to be 12 m²g⁻¹ and 0.084 cm³g⁻¹, and 8 m²g⁻¹ and 0.051 cm³g⁻¹, respectively (FIGS. 7B and 7C).

As expected, the BJH plots revealed that Cu₉S₅/NC had mesoporosity with a size 2-8 nm larger than Cu₉S₅ (FIG. 7C). Accordingly, it is expected that the larger surface area and porous structure of Cu₉S₅/NC will provide more exposed active sites for a NRR electrocatalyst as compared to the unsupported Cu₉S₅ (FIG. 7C).

Electrochemical NRR Activity

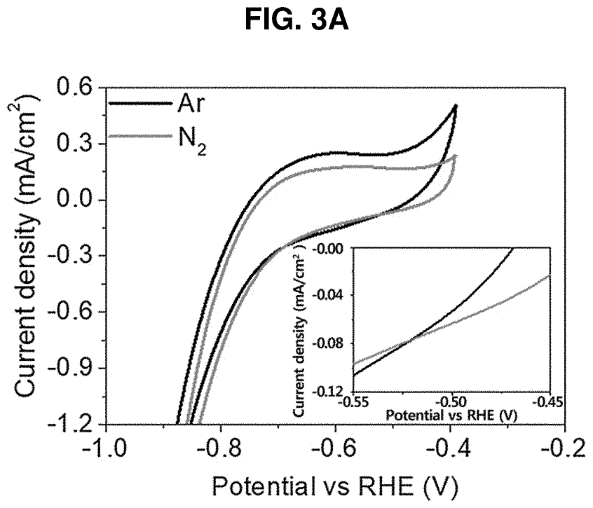

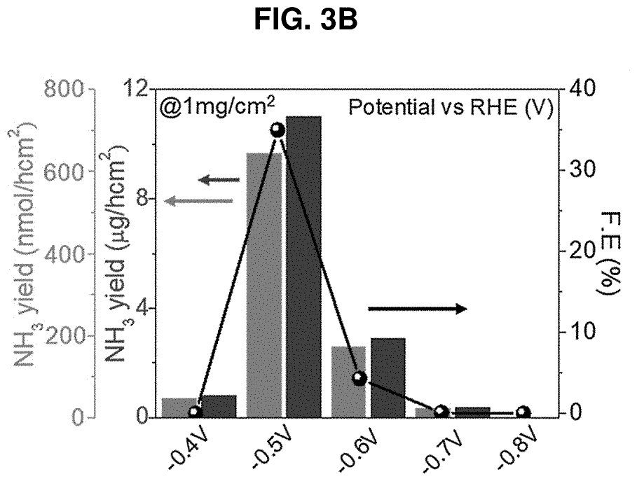

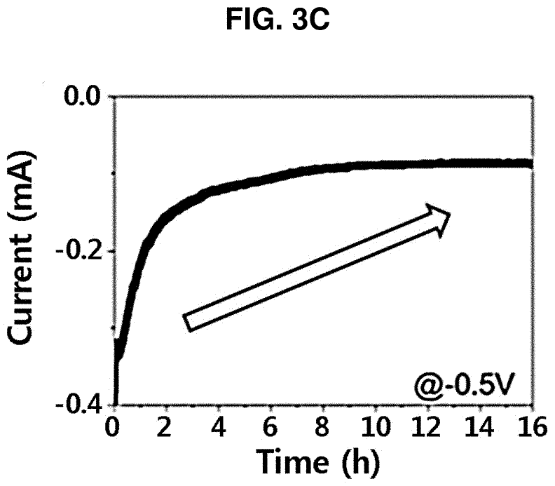

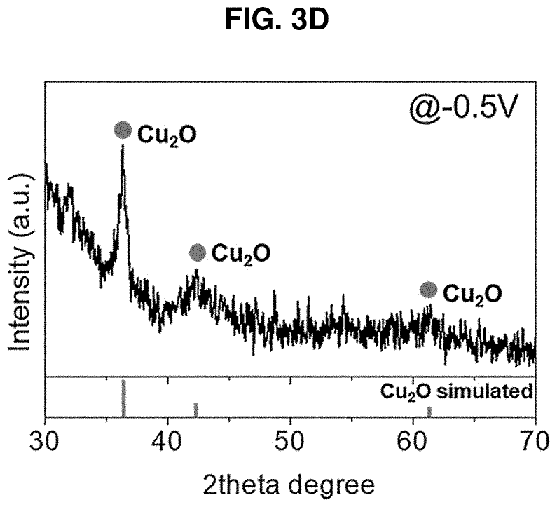

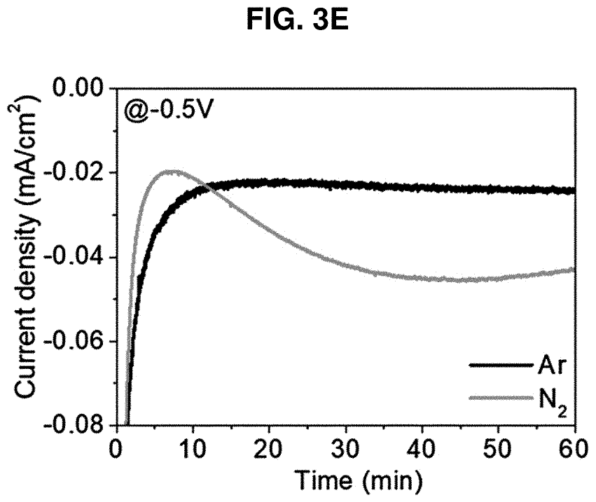

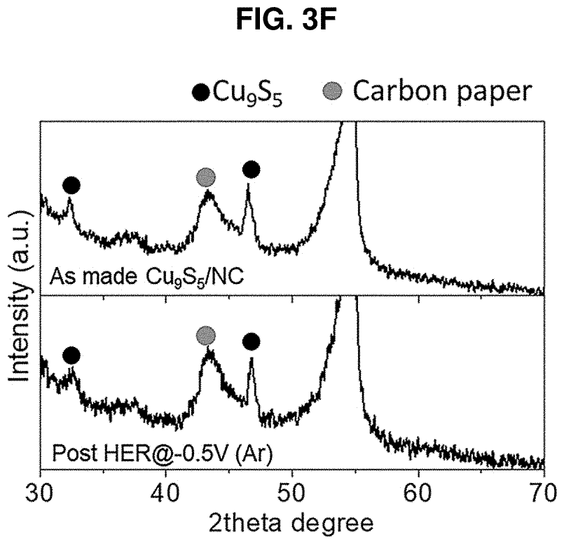

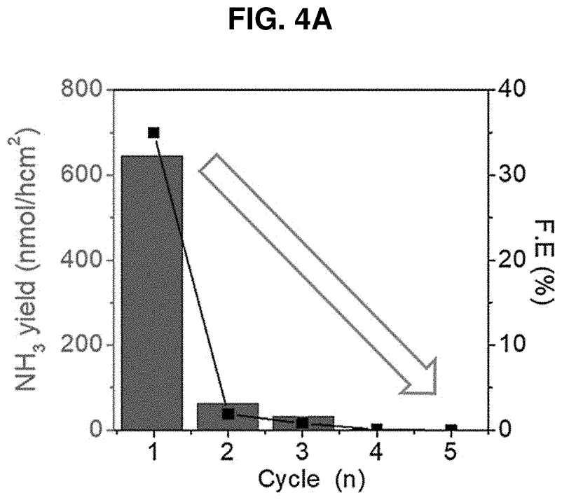

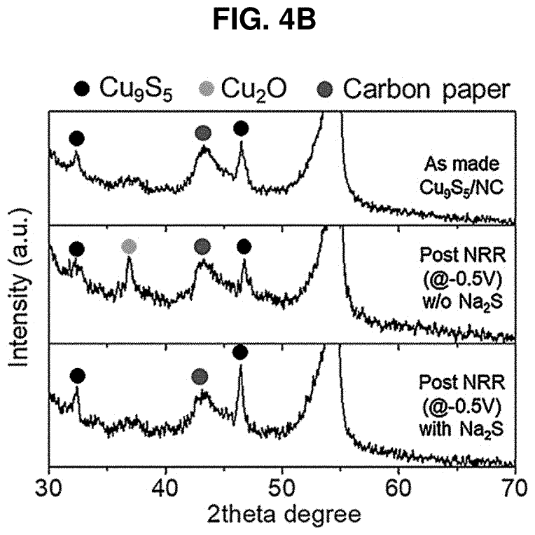

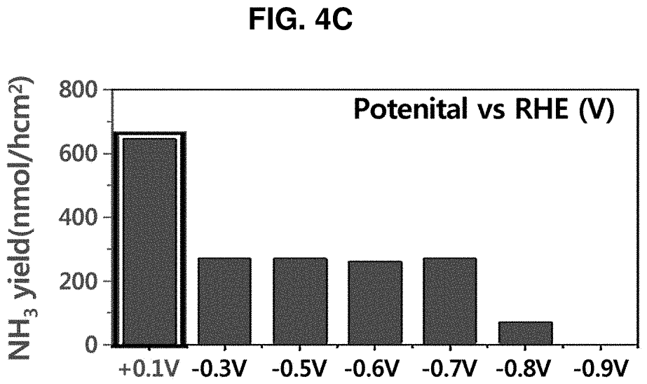

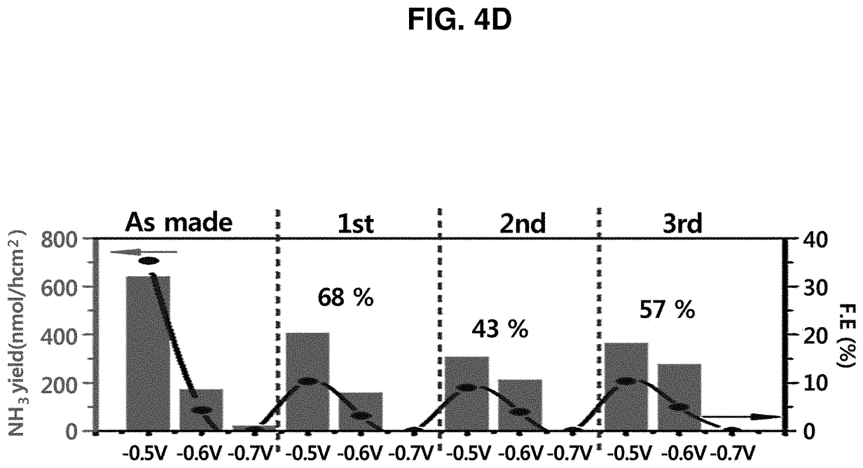

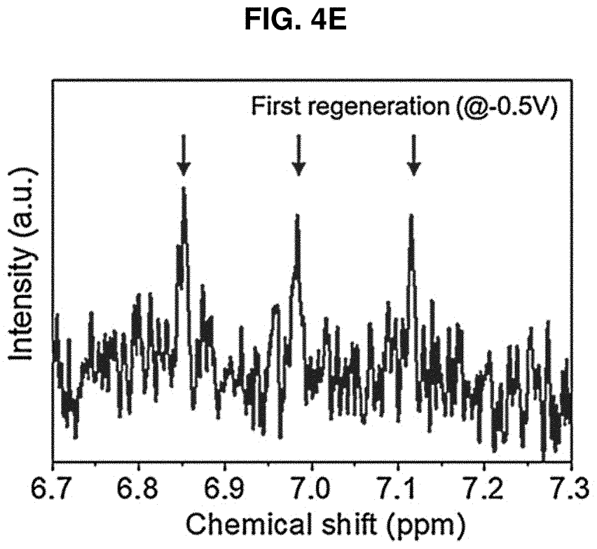

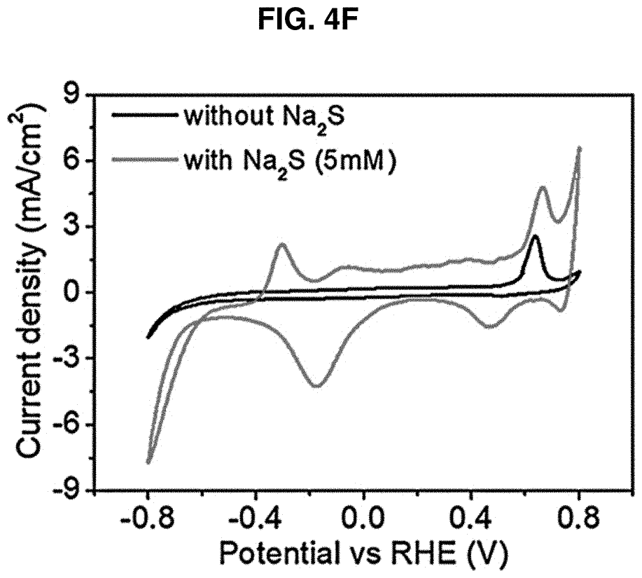

The NRR performance of Cu₉S₅/NC was investigated in a N₂-saturated 0.5 M Na₂SO₄ electrolyte using a H-cell under an ambient condition (FIG. 3A). In CV analysis, the current density of N₂-saturated electrolyte solution did not show distinct difference from that observed in an Ar-saturated solution. Whereas it is difficult to find a unique peak current or onset potential for NRR, the onset potential for hydrogen evolution reaction (HER) is clearly detected at about −0.7 V_{RHE} under N₂ and Ar atmosphere. Instead, the NRR activity of Cu₉S₅/NC can be estimated only from the amount of NH₃ detected in the electrolyte solution after CA for 1 hour at different potentials (FIG. 3B). However, the current observed in CV and CA was changed with time, as can be seen from the changed double layer charging current in the continuous CV cycles (FIG. 3A). This is mainly due to the change in Cu₉S₅ composition under the electrochemical reaction condition (FIG. 4B). If the catalyst is unstable and the NRR activity is limited when compared with HER or degradation current, it is difficult to estimate NRR activity from CV. Accordingly, a longer time period was used in order to investigate the NRR activity and FE of Cu₉S₅/NC from CA at different potentials.

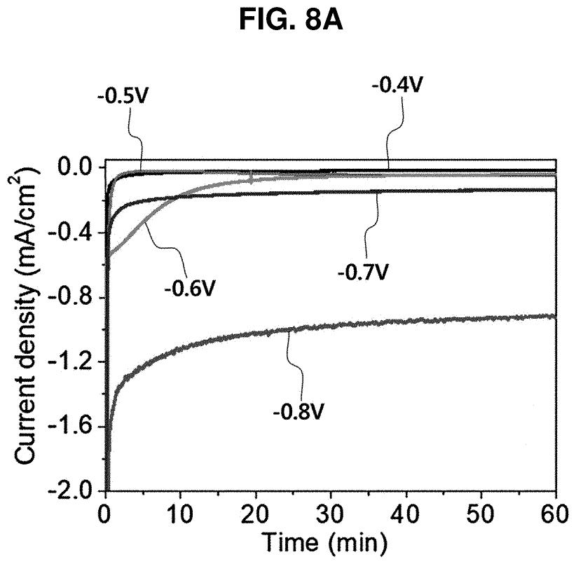

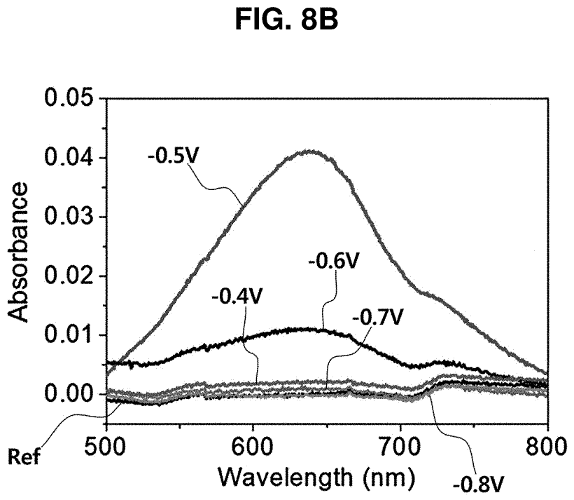

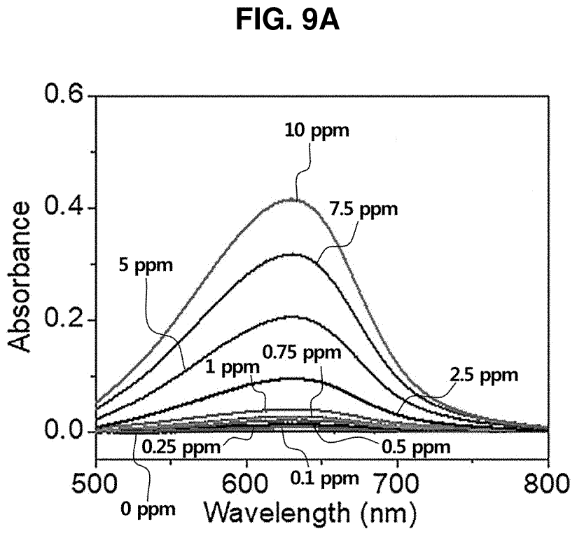

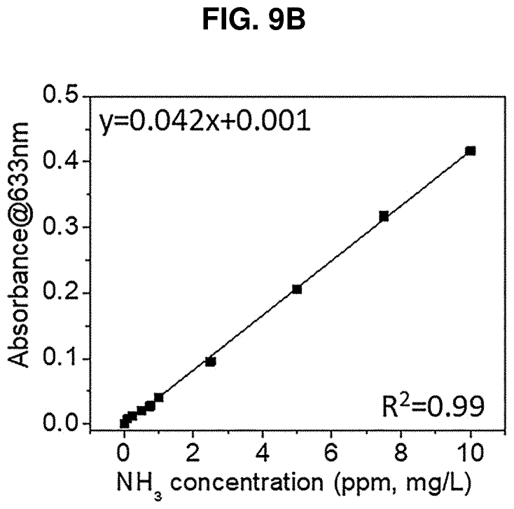

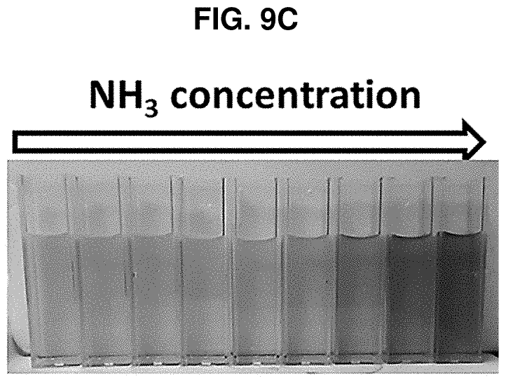

In order to measure the NRR activity of the Cu₉S₅/NC and Cu₉S₅ catalysts, chronoamperometry (CA) was conducted in a N₂-saturated 0.5 M Na₂SO₄ electrolyte at different potentials in the range from −0.4 to −0.8 V_{RHE} (FIG. 3B and FIG. 8). The UV-Vis spectra of an indophenol blue solution prepared from the electrolyte solution after the CA experiment are shown in FIG. 9. NH₃ yield was calculated from absorption at 633 nm after subtracting background absorption from a blank solution and comparing with a standard calibration curve (FIG. 9). For the Cu₉S₅/NC surface, the NH₃ production yield reached 11 μg/hcm² (or 645 nmol/hcm²) at −0.5 V_{RHE} (FIG. 3B). The maximum NH₃ production yield corresponded to a current density of 52 μA/cm², which is 35% (FE) of total average current density measured at −0.5 V_{RHE}. The NRR performance of Cu₉S₅/NC was similar to the highest performance of NRR catalysts reported in previous literatures (see Table 1).

TABLE 1
Comparison of NRR performance of various samples with
previously known data

| | | | NH₃ yield | NH₃ yield | |
|---|---|---|---|---|---|
| Sample | Electrolyte | FE (%) | (μg/hmg_{cat}) | (nmol/hcm²) | Reference |
| Cu₉S₅/NC | 0.5M | 35 | 11.0 | 645 | The present |
| | Na₂SO₄ | | 11.0 μg/hcm² | | disclosure |
| Fe_{SA}-N-C | 0.1M KOH | 56.55 | 7.48 | — | Non-patent |
| | | | | | document 1 |
| SnO₂/RGO | 0.1M | 7.1 | 25.6 | — | Non-patent |
| | Na₂SO₄ | | | | document 2 |
| Mo₂C/C | 0.5M | 7.8 | 11.3 | — | Non-patent |
| | Li₂SO₄ | | | | document 3 |
| γ-Fe₂O₃ | 0.1M KOH | 1.96 | — | 44 | Non-patent |
| | | | | | document 4 |
| Au-Ni | 0.05M | 67.8 | 7.4 | — | Non-patent |
| | H₂SO₄ | | | | document 5 |
| a-Au/CeOx- | 0.1M HCl | 8.3 | 10.1 | — | Non-patent |
| RGO | | | | | document 6 |
| ISAS-Fe/NC | 0.1M PBS | 18.6 | 62.9 | — | Non-patent |
| | | | | | document 7 |
| BiNCs/CB/GC | 0.5M | 67 | — | 6.2 × 10⁻³ | Non-patent |
| | K₂SO₄ | | | (mmol/hcm²) | document 8 |
| CoSx/NS-G | 0.05M | 25.9 | 25 | — | Non-patent |
| | H₂SO₄ | | | | document 9 |
| N,B-FC | 0.1M HCl | 10.6 | 16.4 | — | Non-patent |
| | | | | | document 10 |
| Au NRs | 0.1M KOH | 4.02 | 1.65 | — | Non-patent |
| | | | | | document 11 |
| NPC | 0.1M HCl | 4.2 | 0.97 | — | Non-patent |
| | | | | | document 12 |
| SACs-MoS₂- | 0.1M KOH | 31.6 | 91.5 | — | Non-patent |
| Fe-2.0 | | | (μg/hcm²) | | document 13 |
| Ru SAs/N-C | 0.05M | 29.6 | 120.9 | — | Non-patent |
| | H₂SO₄ | | | | document 14 |

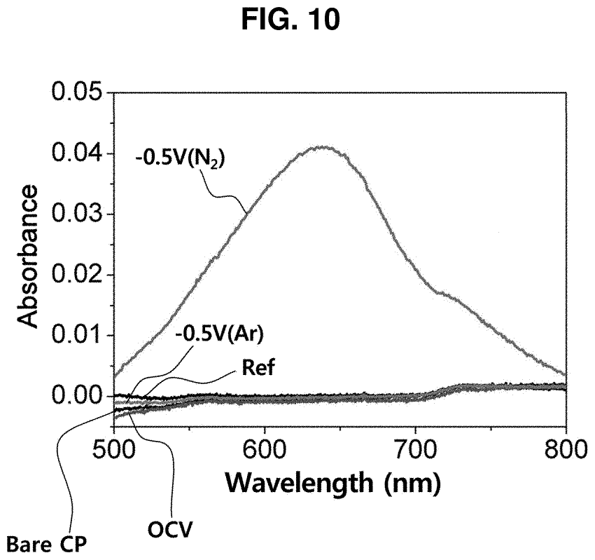

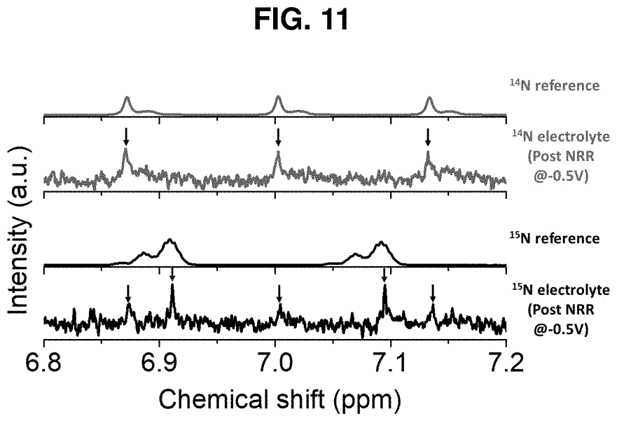

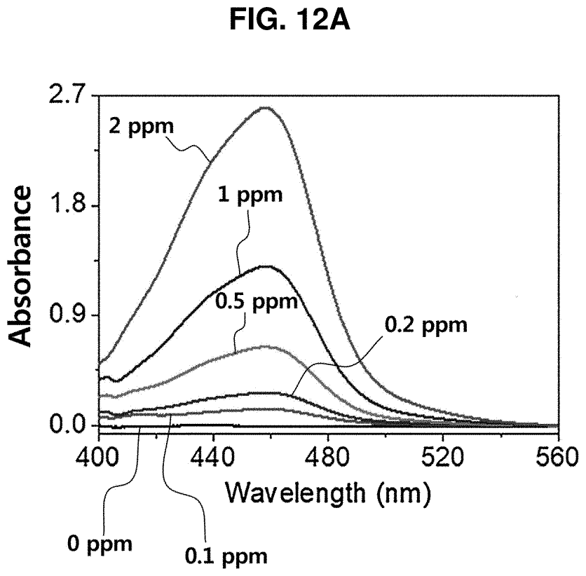

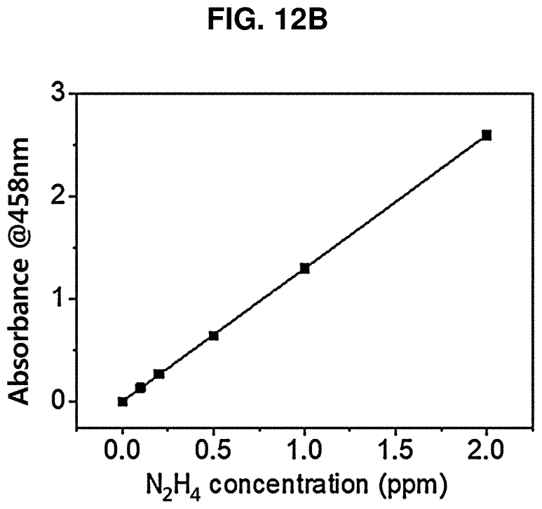

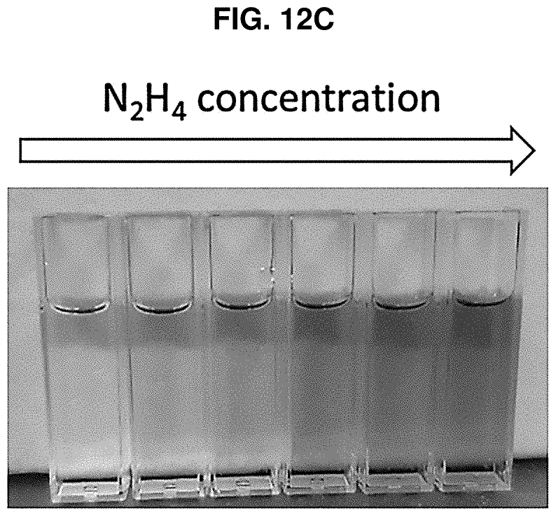

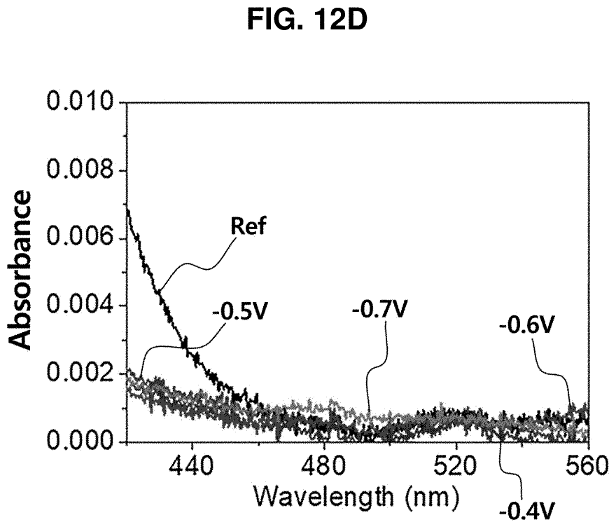

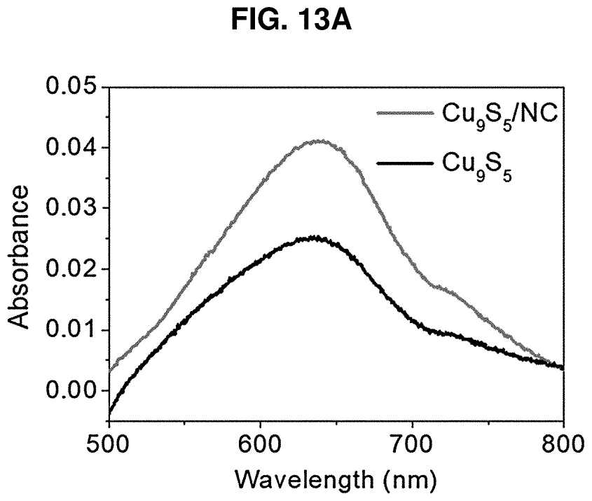

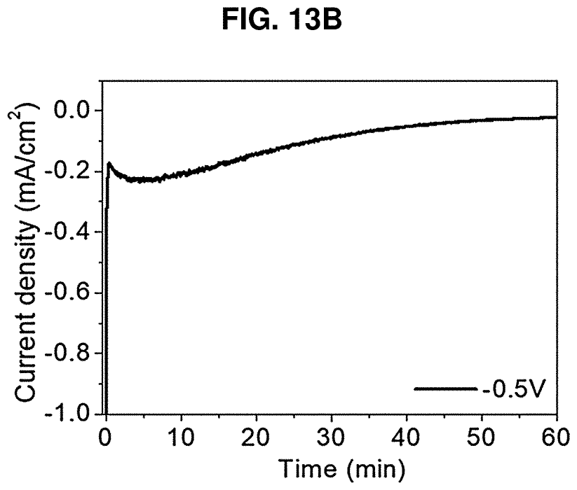

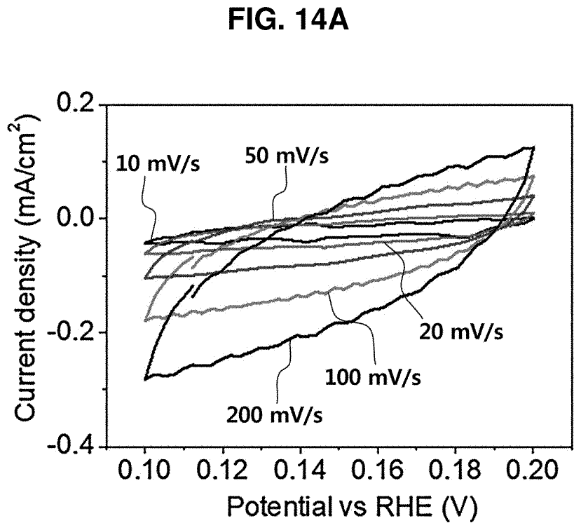

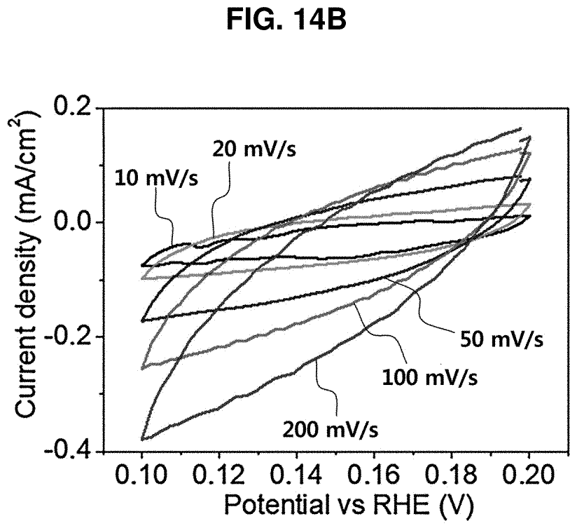

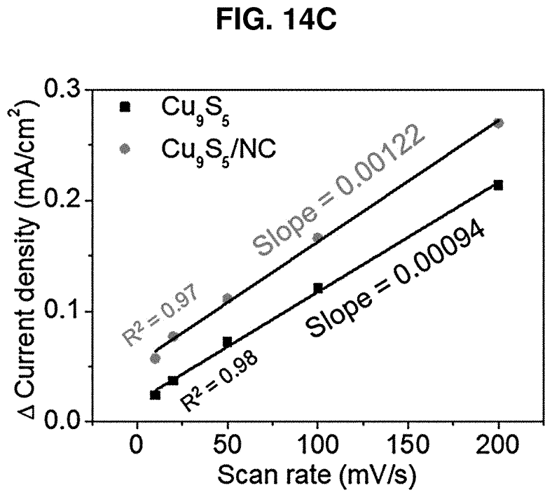

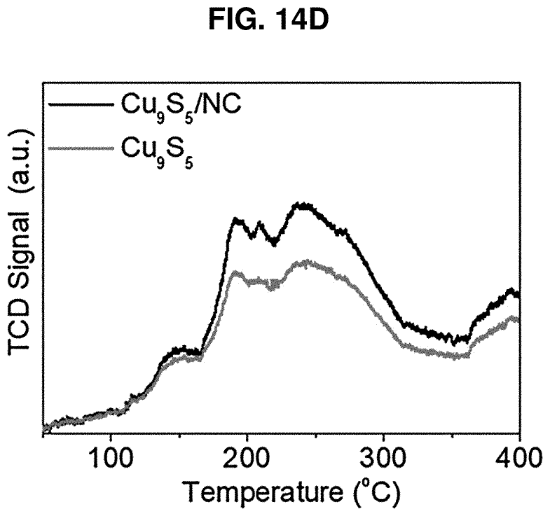

Additional controlled CA experiment was conducted to confirm the electrochemical NRR result obtained with the Cu₉S₅/NC catalyst. The conditions of the controlled experiment are as follows: (1) Cu₉S₅/NC-free carbon paper under N₂ atmosphere, (2) Cu₉S₅/NC electrode under N₂ atmosphere, open-circuit potential with no voltage applied, and (3) Cu₉S₅/NC, −0.5 V_{RHE} in an Ar-saturated 0.5 M Na₂SO₄ electrolyte solution (FIG. 10). Under these conditions, a negligible amount of NH₃ was produced. This experiment confirms that NH₃ was synthesized by electrochemical NRR at controlled potentials in the presence of the supplied N₂ gas. The production of NH₃ was additionally supported ¹H (¹⁴N and ¹⁵N) NMR analysis and colorimetric observation (FIG. 11). In 1H NMR, the triplet and doublet peaks of ¹⁴NH₃ and ¹⁵NH₃ were observed. This strongly supports that NH₃ was generated in the electrolyte solution by electrochemical NRR. Although the production of N₂H₄ by side reactions during NRR was investigated by the Watt and Chrisp method, no N₂HA was detected (FIGS. 12C and 12D). Thus, the inventors of the present disclosure concluded that the Cu₉S₅/NC catalyst produces NH₃ via electrochemical fixation of N₂ under ambient conditions. In order to investigate the effect of NC on the NRR activity of Cu₉S₅/NC, the NRR activity of the Cu₉S₅ catalyst was measured in a 0.5 M Na₂SO₄ electrolyte (FIG. 13). The Cu₉S₅ catalyst exhibited an FE of 7.0% and a reaction rate of 7.9 μg/hcm² (420 nmol/h cm²) at −0.5 V_{RHE}. When compared with Cu₉S₅/NC, the activity was lower by 35% and the selectivity (FE) was lower by 80%. The difference in the NRR activity and the selectivity is partially due to SSA (FIGS. 7B and 7C) and difference in composition. The result of measuring the conductive surface area of Cu₉S₅ and Cu₉S₅/NC also shows clearly that Cu₉S₅/NC has a larger active surface area than Cu₉S₅, which is evidenced by a 24% steeper slope depending on scan rate in the plot of the charging current density (FIGS. 14A-14C). In addition, the N₂-TPD analysis result shows that Cu₉S₅/NC has 28% more N₂-adsorbed sites (which are favorable for NRR) as compared to Cu₉S₅ (FIG. 14D). In addition, since NC is semiconducting and allows facile transport of electrons between Cu₉S₅ and the supporting electrode (carbon paper), unnecessary ohmic drop may be reduced using the electrode. Due to the advantage of the Cu₉S₅/NC composite structure, the degradation and regeneration of the Cu₉S₅ catalyst for NRR were studied further.

Degradation and Regeneration of Catalyst

In general, the electrochemical reaction rate (i.e., current) is improved with increased overpotential. The exponential increase of current at applied overpotential is explained by the Butler-Volmer equation using two simple variables of transfer coefficient and overpotential. The NRR and FE of Cu₉S₅/NC decreased greatly at higher negative potentials (see Table 2, FIG. 3B and FIG. 8B).

TABLE 2
J_{NH3}, FE and NH₃ yield of Cu₉S₅/NC
catalyst depending on potential (vs RHE)

| Potential | j_{NH3} | FE | NH₃ yield | NH₃ yield | NH₃ yield |
|---|---|---|---|---|---|
| (vs RHE) | (μA/cm²) | (%) | (μg/hmg_{cat}) | (nmol/cm²) | (μg/hcm²) |
| −0.4 V | 0.05 | 0.01 | 0.8 | 47 | 0.8 |
| −0.5 V | 52 | 35 | 11 | 645 | 11 |
| −0.6 V | 14 | 4.3 | 2.9 | 173 | 2.9 |
| −0.7 V | 1.8 | 0.12 | 0.37 | 22 | 0.37 |
| −0.8 V | 0 | 0 | 0 | 0 | 0 |

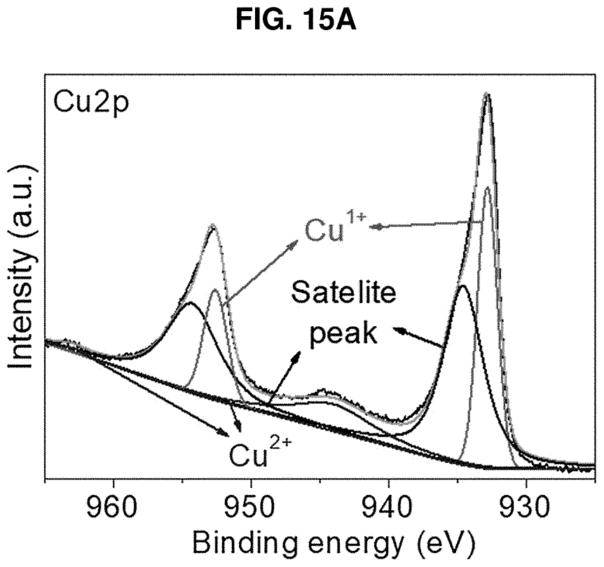

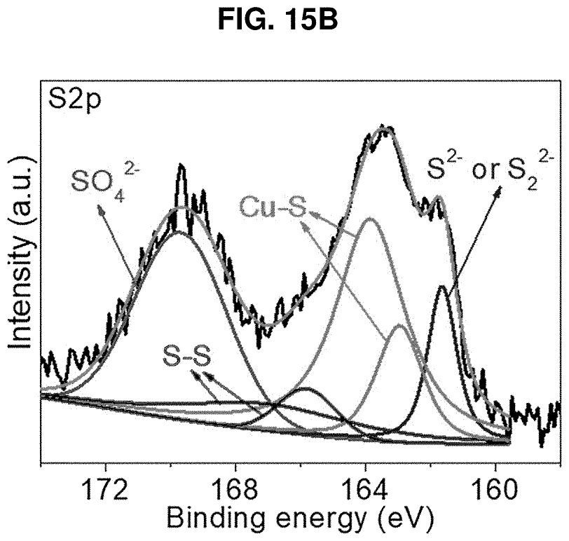

The NH₃ production rate was decreased from 645 to 22 nmol/hcm² as the applied potential was increased from −0.5 to −0.7 V_{RHE}, and then to 0.37 μg/hcm² at a potential of 11 V_{RHE}. The inverse relationship between the NRR activity and the overpotential may be derived from two possible effects: (i) N₂ adsorption may be interrupted on more negative surface, and proton adsorption and reduction may dominate the reduction reaction, or (ii) the catalyst activity may be lost as the surface is actually changed or electrochemically degraded at potential. Although the decrease in reaction rate with increased overpotential was proposed in the inverted Marcus region for electrochemical reactions, it was not considered in the present disclosure. The decrease in NRR activity at higher overpotential for Cu₉S₅/NC was observed as decreased current density, which is commensurate with both HER and NRR in extended CA experiments under N₂ atmosphere (FIG. 3C). The total current density of Cu₉S₅/NC was decreased from −0.4 to −0.1 mA/cm² at −0.5 V_{RHE} during CA for 16 hours. Additionally, the surface degradation of the Cu₉S₅/NC catalyst was investigated by XRD following the CA at −0.5 V_{RHE} for 16 hours, after the NRR activity measurement (FIG. 3D). The cubic pattern of Cu₂O appeared whereas the intensity of the XRD peak corresponding to the hexagonal Cu₉S₅ was decreased rapidly immediately after the reduction reaction (FIG. 3D). More interestingly, the change in CA and catalyst structure was observed in the N₂-saturated aqueous solution only, whereas the reduction current and crystal structure remained intact after HER in the Ar-saturated electrolyte solution at −0.5 V_{RHE} for 1 hour. The XRD analysis showed that the structure of Cu₉S₅ was maintained after the HER at −0.5 V_{RHE} in the Ar-saturated aqueous solution (FIGS. 3E and 3F). This means that the catalyst surface was reconstituted after the NRR, not after the HER. In other words, although the strong adsorption of N₂ onto the Cu—S surface breaks the unstable Cu—S bond and forms Cu₂O during NRR, the decrease in protons does not change the surface structure. The XPS analysis of the Cu₉S₅/NC catalyst after the NRR (FIGS. 15A and 15B) shows that the XPS spectra of Cu 2p are not significantly different from those of Cu₉S₅/NC, because Cu₂O and Cu₉S₅ are similar in oxidation state and electron binding energy. However, the peaks of sulfur anions (S²⁻ or S₂²⁻ at 161.5 eV) dissolved during the NRR process appear in the S 2p spectra, together with the peak of SO₄²⁻ at 170 eV from the Na₂SO₄ electrolyte (FIG. 15B). The peaks of the Cu—S and S—S bonds of Cu₉S₅ were still observed after the degradation. However, whereas the sulfur content was decreased rapidly after the NRR, the oxygen content was increased (see Table 3).

TABLE 3
Atomic ratio of Cu, S and O of as-prepared Cu₉S₅/NC and
after NRR at −0.5 V_{RHE} estimated from XPS spectra

| | Initially | After NRR at |
|---|---|---|
| Element | (as-prepared) (at %) | −0.5 V (at %) |
| Cu | 61.9 | 22 |
| S | 33.8 | 9.4 |
| O | 4.3 | 68.8 |

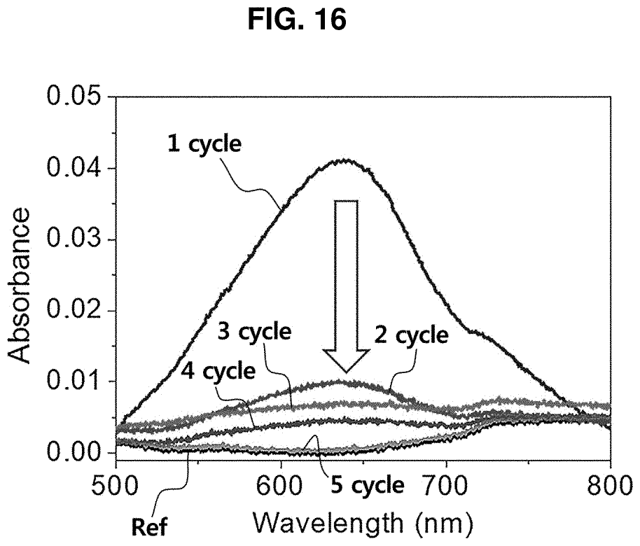

Referring to FIG. 4A and FIG. 16, the results of XRD and XPS support the electrochemical degradation of Cu₉S₅/NC, together with the decreased NRR activity due to repeated CA at 0.5 V_{RHE}. The decrease in NRR activity at higher overpotentials is due to the degradation of the catalyst surface under the electrochemical reaction condition. Under reducing environments, the electrochemical formation of Cu₂O from Cu₉S₅ may occur according to the following half-reaction.

10Cu_{1.8}S+10H₂O+2e⁻→9Cu₂O+10H₂S+O²⁻

Although the faradaic peak current associated with the reductive degradation of Cu₉S₅ was not clearly observed in CV, the structural change and activity loss at more negative potentials than −0.5 V_{RHE} strongly suggests the electrochemical degradation of the catalyst.

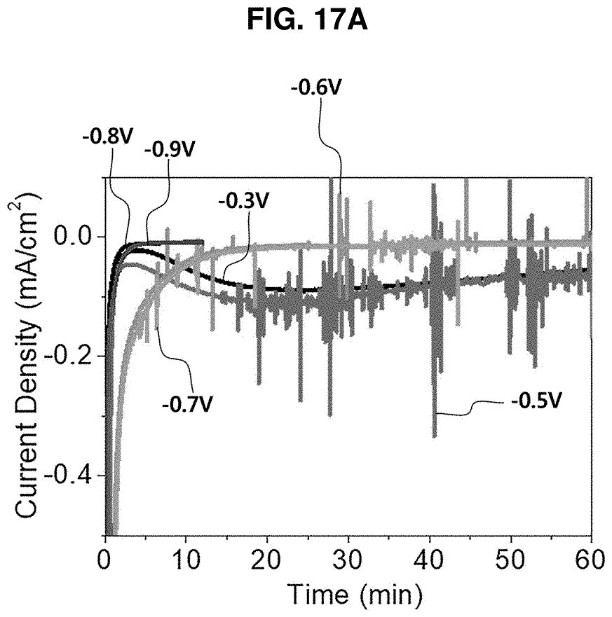

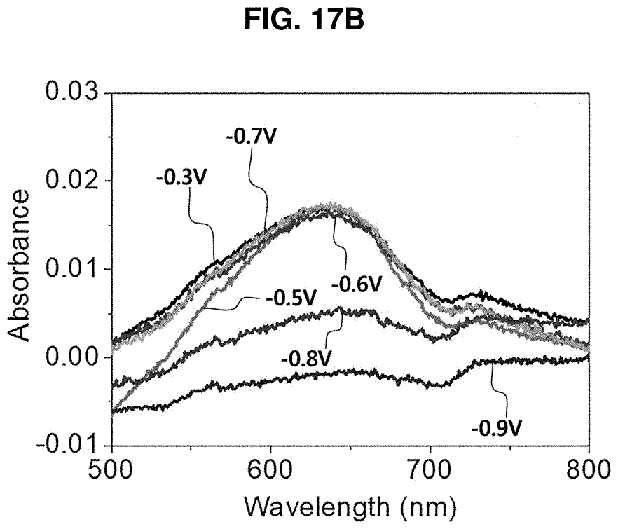

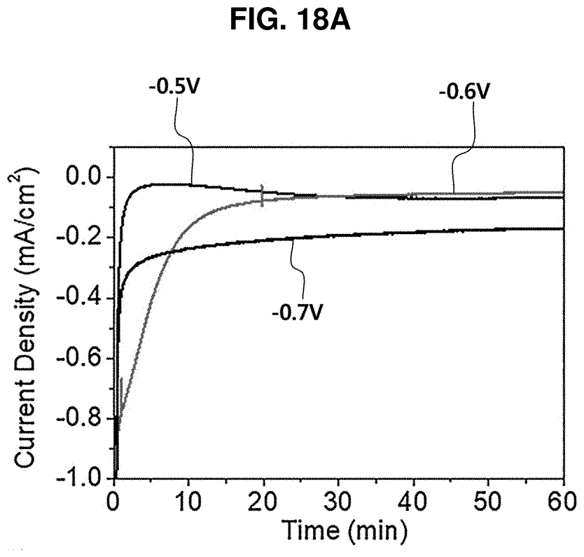

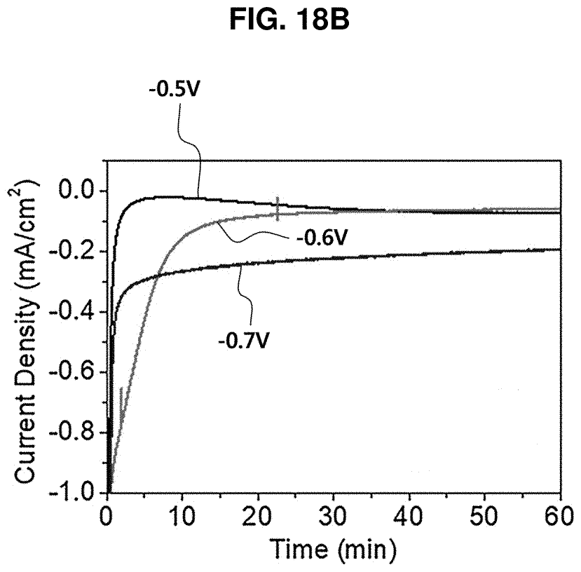

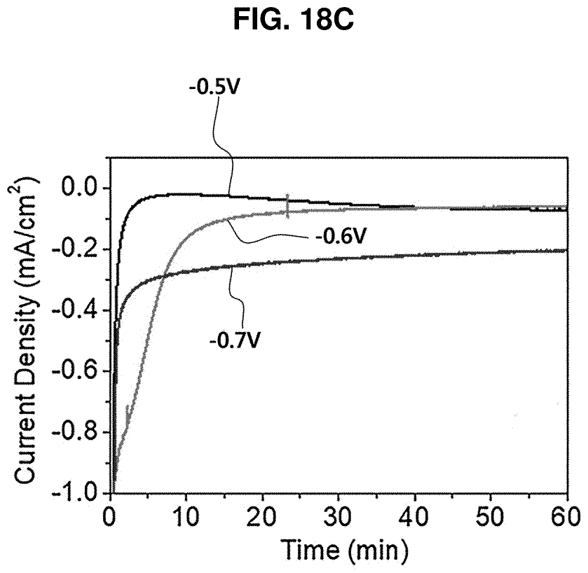

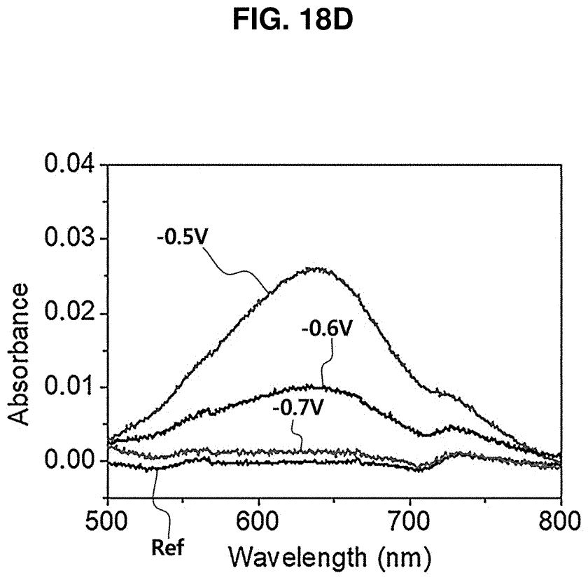

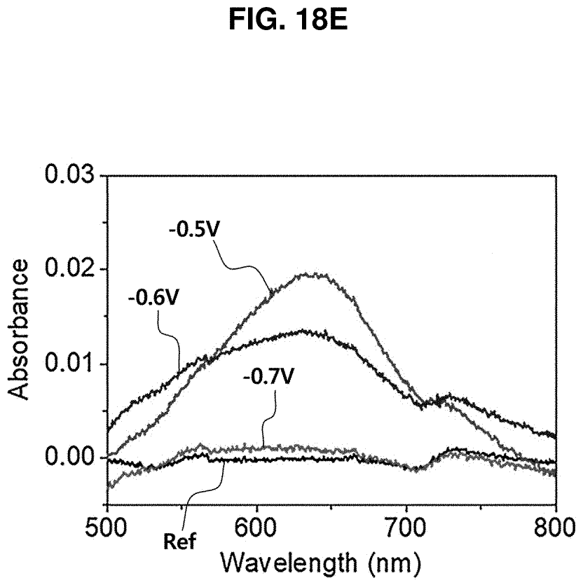

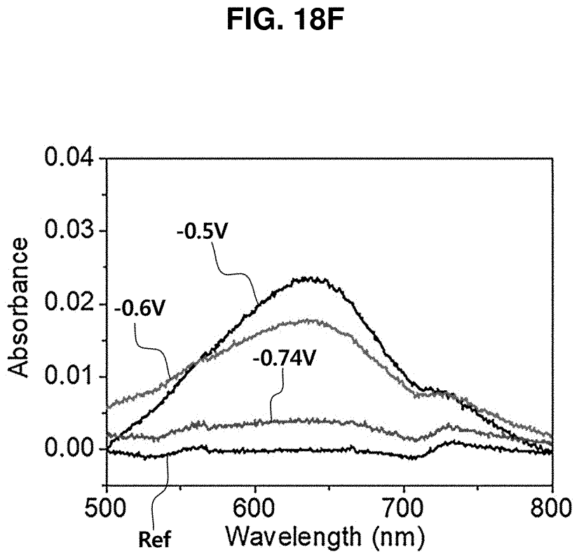

The inventors of the present disclosure hypothesized that the Cu—S bond is cleaved during NRR and the restoration of the Cu—S bond will recover NRR activity. Therefore, in order to mimic the unstable chemistry of the sulfhydryl group of the FeMo cofactor and restore NRR activity, ex-situ electrochemical sulfurization reaction was used to restore the Cu—S bond on the Cu₉S₅/NC surface. Specifically, a degraded Cu₉S₅/NC electrode was re-oxidized by CA in 5 mM Na₂S and 0.5 M Na₂SO₄ aqueous solutions for 1 hour at a potential in the range from −0.9 to 0.1 V_{RHE} (FIG. 4B and FIGS. 17A-17B). Then, the electrode was subjected to NRR under N₂ atmosphere in a fresh 0.5 M Na₂SO₄ aqueous solution (FIG. 4C). Importantly, the NRR activity was recovered at the Cu₉S₅/NC electrode which was treated at more positive potential than −0.7 V_{RHE} in the 5 mM Na₂S solution. The electrochemical regeneration process is described in detail in FIG. 5. The restoration of the Cu₉S₅ structure was confirmed by XRD. The diffraction pattern of hexagonal Cu₉S₅ appeared again in the regenerated electrode, whereas the peaks of Cu₂O decreased significantly (FIG. 4B). Through continuous NRR/regeneration of 4 cycles, the NIH3 production speed was recovered to 68, 43 and 57%, respectively, as compared to the initial NRR of a fresh Cu₉S₅/NC electrode (see FIG. 4D, FIGS. 18A-18F and Table 4).

TABLE 4
NRR performance after electrochemical regeneration
process depending on cycle number

| Regeneration | Potential | FE | NH₃ yield |
|---|---|---|---|
| cycle | (vs RHE) | (%) | (nmol/hcm²) |
| As-prepared | −0.5 V | 35 | 645 |
| Cu₉S₅/NC | −0.6 V | 4.3 | 173 |
| | −0.7 V | 0.12 | 22 |
| 1st regeneration | −0.5 V | 10.3 | 406 |
| | −0.6 V | 3.2 | 159 |
| | −0.7 V | — | — |
| 2nd regeneration | −0.5 V | 9.0 | 308 |
| | −0.6 V | 4.0 | 212 |
| | −0.7 V | — | — |
| 3rd regeneration | −0.5 V | 10.4 | 365 |
| | −0.6 V | 5.0 | 278 |
| | −0.7 V | — | — |

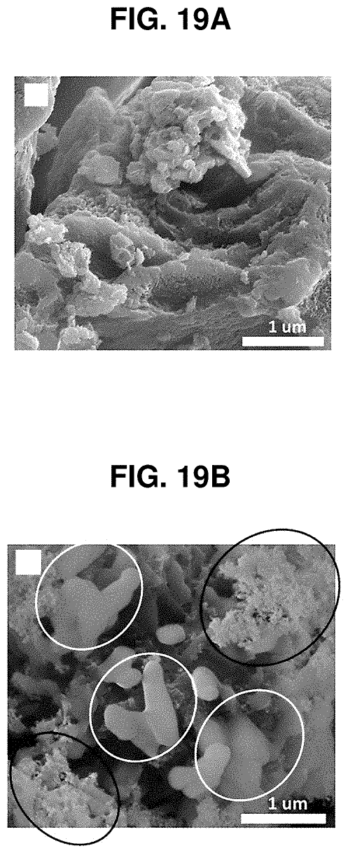

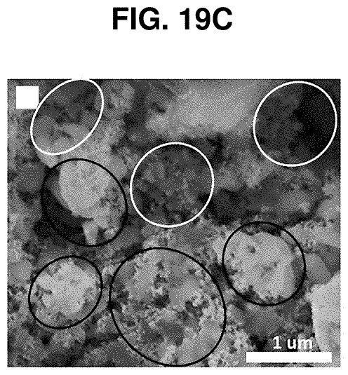

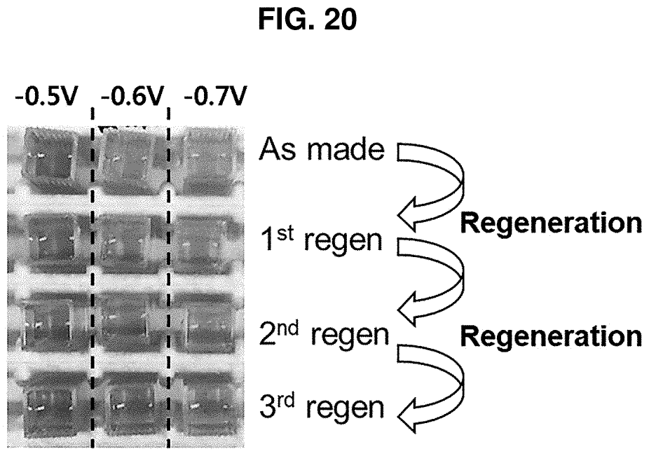

However, the Cu₉S₅/NC composite structure shown in FIG. 1C was disrupted and, Cu₂O and NC were separated during the repeated NRR/regeneration process as observed by SEM (FIGS. 19A-19C). In addition, the NRR activity was not completely recovered to the NRR activity of the original composite structure. NH₃ production by the regenerated electrode was confirmed by ¹H NMR and the colorimetric method (FIG. 4E). Both NMR and indophenol blue analyses showed that the NRR performance of the catalyst was recovered by the electrochemical regeneration (FIG. 20). The regeneration of the Cu₉S₅ structure from Cu₂O can proceed by the following oxidation process.

9Cu₂O+10Na₂S+11H₂O→10Cu_{1.8}S+20NaOH+2H⁺+2e⁻

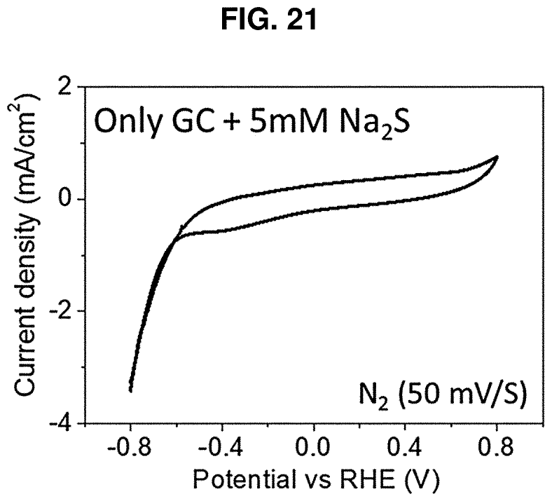

It is reported that a Cu substrate is oxidized in an electrolyte solution in the presence of a sulfide at more positive potentials than approximately −0.8 V_{RHE} to form CuₓS (Cu₂S and Cu₉S₅). In a previous study, a small bumpy current was recorded at about −0.8 V_{RHE} in CV for forming CuₓS from a Cu substrate. In addition, a large oxidation current was not detected at a potential around −0.8 V_{RHE} from CV in 5 mM Na₂S using a degraded Cu₉S₅ electrode (FIG. 4F). In FIG. 4F, the peak oxidation current observed at −0.3 V_{RHE} originates from the Sₙ²⁻/S²⁻ redox reaction on the Cu₉S₅ surface. However, no similar oxidation current was observed when a carbon electrode was used in an electrolyte solution or in the absence of a sulfide (FIG. 4F and FIG. 21).

The increased NRR activity of the regenerated Cu₉S₅/NC electrode and its crystal structure strongly suggest that the Cu—S bond is regenerated by the electrochemical treatment. The result also suggests that the metal-sulfur bond is very important in the electrochemical NRR process. The Cu—S bond was broken in the NRR process only and was not affected in an aqueous solution in the absence of N₂. In the FeMo cofactor of nitrogenase, the Fe center provides an adsorption site for N₂ adsorption. The Fe—S bond is broken during the N₂ adsorption process, and the atomic hydrogen transferred to the cofactor approaches Fe—N₂ and forms a sulfhydryl group. Then, the sulfhydryl group is involved in hydrogenation processes including reductive removal of H₂ molecules. A similar adsorption mechanism was proposed in the electrochemical N₂ reduction reaction. The N₂Hx intermediate on the electrocatalyst surface was observed through in-situ IR measurement, which supports the related adsorption mechanism under ambient condition. The NRR activity of the metal sulfide catalyst was also reported. However, the role of sulfur in the electrochemical NRR process has not been elucidated yet. The NRR activity observed on the Cu₉S₅/NC surface disappears when the metal-sulfur bond is broken. Importantly, the catalyst activity is recovered through sequential NH₃ production and catalyst regeneration cycles. These results mean that the metal-sulfur bond is important in the electrochemical production of NH₃ and is actively involved in the electrochemical N₂ reduction process.

In summary, the use of the Cu₉S₅/NC catalyst as a NRR catalyst resulted in significant NH₃ production, activity and selectivity (11.0 μg/h cm², 645 nmol/h cm² and 35%, respectively). Importantly, the Cu₉S₅ catalyst was degraded to Cu₂O during the NRR process and the catalyst activity was decreased. Subsequently, the Cu₉S₅ surface was reconstructed from the degraded electrode through an electrochemical sulfurization process. The importance of the metal-sulfur bond in NRR was demonstrated by the recovered NH₃ production yield of the recovered Cu₉S₅/NC surface. The degradation and regeneration processes of the metal chalcogenide catalyst for electrochemical NH₃ production are similar to the enzymatic N₂ fixation process discovered in the FeMo cofactor of nitrogenase. In addition, this result strongly suggests that, in order to achieve effective electrochemical NH₃ production under ambient condition, a powerful catalyst that provides an unstable sulfhydryl functional group favored by the metal center for N₂ adsorption is necessary.

To conclude, in the present disclosure, Cu₉S₅/NC was prepared by a thermal heating reaction using the solid-state method, and an FE of 35% and a yield of 11.0 μg/hcm² (or 645 nmol/hcm²) was achieved in a 0.5 M Na₂SO₄ electrolyte at −0.5 V_{RHE} for electrochemical NH₃ production. However, the crystal structure of Cu₉S₅/NC was degraded to Cu₂O during the NRR reaction. The regeneration redox cycle of metal sulfide was first demonstrated in the present disclosure. The Cu₉S₅ surface was reconstructed in a 5 mM Na₂S electrolyte via an electrochemical sulfurization process.

The NRR activity of Cu₉S₅/NC was recovered in the reconstructed electrode, and NH₃ production was activated through repeated NRR and regeneration processes. The important of the metal-sulfur bond in NRR can be explained with the NH₃ yield on the recovered Cu₉S₅/NC surface. The degradation and regeneration processes of the metal chalcogenide catalyst for electrochemical NH₃ production show a mechanism similar to the enzymatic N₂ fixation process discovered for the FeMo cofactor of nitrogenase. The result suggests that, in order to achieve effective electrochemical NH₃ production under ambient condition, a powerful catalyst that provides an unstable sulfhydryl functional group favored by the metal center for N₂ adsorption is necessary. Accordingly, the present disclosure provides a new electrochemical regeneration method for a low-durability catalyst used in continuous NRR.

1. A catalyst for electrochemical synthesis of ammonia, comprising a copper-sulfur compound and N-doped carbon.

2. The catalyst for electrochemical synthesis of ammonia according to claim 1, wherein the copper-sulfur compound is represented by the chemical formula CuₓS_{y} (wherein x is 1.7-1.8 when y is 1).

3. The catalyst for electrochemical synthesis of ammonia according to claim 1, wherein the copper-sulfur compound is represented by the chemical formula of Cu₉S₅.

4. The catalyst for electrochemical synthesis of ammonia according to claim 1, wherein the copper-sulfur compound and the N-doped carbon are complexed with each other and dispersed throughout the catalyst.

5. The catalyst for electrochemical synthesis of ammonia according to claim 1, wherein a mass ratio of the copper-sulfur compound is 65-85% based on the total mass of the catalyst.

6. The catalyst for electrochemical synthesis of ammonia according to claim 1, wherein the catalyst has a size of 0.1-10 μm.

7. The catalyst for electrochemical synthesis of ammonia according to claim 1, wherein the catalyst has a specific surface area (SSA) of 5-20 m²g⁻¹.

8. The catalyst for electrochemical synthesis of ammonia according to claim 1, wherein the catalyst has a total pore volume of 0.001-0.15 cm³g⁻¹.

9. The catalyst for electrochemical synthesis of ammonia according to claim 1, wherein the catalyst has an ammonia production yield of 600 nmol/hcm² or higher at −0.5 V_{RHE}.

10. The catalyst for electrochemical synthesis of ammonia according to claim 1, wherein the catalyst can be regenerated using Na₂S.

11. An electrode for electrochemical synthesis of ammonia, comprising the catalyst for electrochemical synthesis of ammonia according to f claim 1.

12. A method for preparing a catalyst for electrochemical synthesis of ammonia, comprising:
a step of preparing a mixture of a copper precursor comprising N and a sulfur precursor comprising C and N; and
a step of heat-treating the mixture.

13. The method for preparing a catalyst for electrochemical synthesis of ammonia according to claim 12, wherein
the copper precursor is Cu(NO₃)₂.6H₂O, and
the sulfur precursor is CH₄N₂S.

14. The method for preparing a catalyst for electrochemical synthesis of ammonia according to claim 12, wherein, in the step of preparing the mixture, the copper precursor and the sulfur precursor are pulverized and mixed.

15. The method for preparing a catalyst for electrochemical synthesis of ammonia according to claim 12, wherein the step of heat-treating the mixture is performed by a solid-state reaction.

16. The method for preparing a catalyst for electrochemical synthesis of ammonia according to claim 12, wherein the step of heat-treating the mixture is performed at 400-600° C. for 1-5 hours.

17. A method for regenerating the catalyst for electrochemical synthesis of ammonia according to claim 1, comprising:
a step of synthesizing ammonia by electrochemical nitrogen reduction reaction (eNRR) in the presence of the catalyst for electrochemical synthesis of ammonia; and
a step of regenerating the catalyst for electrochemical synthesis of ammonia after the step of synthesizing ammonia using Na₂S.

18. The method for regenerating a catalyst for electrochemical synthesis of ammonia according to claim 17, wherein the step of regenerating the catalyst for electrochemical synthesis of ammonia is performed by immersing the catalyst for electrochemical synthesis of ammonia in an aqueous solution comprising Na₂S and an electrolyte.

19. The method for regenerating a catalyst for electrochemical synthesis of ammonia according to claim 17, wherein the step of regenerating the catalyst for electrochemical synthesis of ammonia is performed at a potential of 0.05-0.5 V_{RHE} for 30 minutes to 5 hours.

20. The method for regenerating a catalyst for electrochemical synthesis of ammonia according to claim 17, wherein, after the step of regenerating the catalyst for electrochemical synthesis of ammonia, the step of synthesizing ammonia is repeated using the regenerated catalyst.
